(19) United States
(12) Patent Application Publication
(10) Pub. No.: US 2026/0112190 A1
(43) Pub. Date: Apr. 23, 2026

(54) TABLE CELL DETECTION FOR TABLE STRUCTURE RECOGNITION

(71) Applicant: Adobe Inc., San Jose, CA (US)

(72) Inventors: Parth Shailesh Patel, Vadodara (IN); Yuvraj Raghuvanshi, Varanasi (IN); Sumit Shekhar, Bangalore (IN); Shubh Chaurasia, Maihar Distt-Satna (IN); Paridhi Sachdeva, Noida (IN); Mohit Gupta, Noida (IN); Jeevana Kruthi Karnuthala, Kurnool (IN); Jayant Vaibhav Srivastava, Varanasi (IN)

(73) Assignee: Adobe Inc., San Jose, CA (US)

(21) Appl. No.: 18/923,251

(22) Filed: Oct. 22, 2024

(51) Int. Cl. G06V 30/412

(52) U.S. Cl. CPC G06V 30/412

(57) ABSTRACT

In accordance with the described techniques, a processing device receives a document that includes a table, and uses a machine learning model to detect cells in the table and probabilities assigned to the cells indicating whether respective cells correspond to a row header or a column header of the table. Further, the processing device aligns borders of the cells along horizontal axes of corresponding rows of the table and along vertical axes of corresponding columns of the table. In addition, the processing device generates a table structure based on the aligned cells and the probabilities such that the table structure includes the aligned cells arranged in the rows and columns.

### BACKGROUND

Tables are organizational structures for conveying information. In particular, tables are organized into rows and columns of a grid, such that content (e.g., text, images, figures, and the like) are contained within individual cells of a grid. The table structure of a table includes which cells belong to which rows, which cells belong to which columns, which cells span multiple rows or columns, and which cells are header cells, e.g., row headers or column headers. Understanding the table structure is paramount to understanding the information conveyed by the table.

### SUMMARY

A table structure recognition system is configured to receive a document that includes a table. The table structure recognition system employs a machine learning model to detect cells in the table and probabilities assigned to the cells indicating whether respective cells correspond to a row header or a column header of the table. In one or more implementations, the table structure recognition system employs rules-based algorithms to refine the detected cells. As part of this, the table structure recognition system aligns borders of the cells along horizontal axes of corresponding rows and along vertical axes of corresponding columns, fills gaps between the cells in the table by inserting additional cells or repositioning borders of the cells, and/or removes overlap of overlapping cells by separating or merging the overlapping cells. Furthermore, the table structure recognition system employs rules-based algorithms to generate a table structure based on the refined cells and the probabilities. The table structure includes the cells arranged in and/or assigned to respective rows and columns of the table, as well as row headers and column headers, e.g., cells classified as row headers and column headers based on the probabilities.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ techniques described herein of table cell detection for table structure recognition.

FIG. 2 depicts a system in an example implementation showing operation of a table structure recognition system to generate a table structure for a table in a document.

FIG. 3 depicts a system in an example implementation showing operation of a training data preprocessing system to generate a refined training dataset for training a machine learning model.

FIG. 4 depicts an example of consistent table boundaries being defined by the training data preprocessing system.

FIG. 5 depicts an example of table boundaries of a borderless table being defined by a training data preprocessing system.

FIG. 6a, FIG. 6b, and FIG. 6c depict a system in an example implementation showing operation of a postprocessing system to process model outputs of a machine learning model to generate table structures for one or more tables in a document.

FIG. 7 depicts an example of a postprocessing technique to insert additional cells and merge the additional cells.

FIG. 8 depicts an example of a postprocessing technique to reposition detected cells within rows and columns along common axes.

FIG. 9 depicts an example of a postprocessing technique to merge or separate overlapping cells.

FIG. 10 depicts an example of a postprocessing technique to reposition borders of detected cells to coincide with borders of adjacent cells.

FIG. 11 depicts an example of a postprocessing technique to reposition borders of detected cells to coincide with a table boundary of a table.

FIG. 12 is a flow diagram depicting a procedure in an example implementation of table cell detection for table structure recognition.

FIG. 13 illustrates an example system including various components of an example device that can be implemented as any type of computing device as described and/or utilized with reference to FIGS. 1-12 to implement embodiments of the techniques described herein.

### DETAILED DESCRIPTION

### Overview

Tables are information formatting structures having rows and columns arranged in a grid, such that content (e.g., letters, numbers, symbols, images, figures, graphics, and the like) is placed within individual cells of the grid. The structure of a table conveys information. For example, row headers (e.g., cells that provide context for cells positioned laterally with respect to the row headers), column headers (e.g., cells that provide context for cells positioned vertically with respect to the column headers), which rows and columns respective cells belong to, and cell span information (e.g., whether a cell spans multiple rows or multiple columns) are all relevant to understand the information conveyed by a table. While humans have an intuitive sense of understanding table structure, automating the extraction of table structure data is a challenging task, in part, due to the inherent complexity and variability in table layouts. For at least this reason, conventional table structure recognition techniques often inaccurately detect table structure information.

To improve table structure recognition accuracy, techniques of table cell detection for table structure recognition are described herein as implemented by a table structure recognition system. Broadly, the table structure recognition system receives a document that includes a table, and processes the document to generate a table structure of the table. In variations, the table is fully bordered (e.g., the table has visible borders between each row and each column), partially bordered (e.g., the table has visible borders separating some, but not all rows and columns), or borderless, e.g., the table has no visible borders.

In accordance with the described techniques, the table structure recognition module employs a machine learning model (e.g., an object detection model). The machine learning model is trained (e.g., using supervised learning techniques) to detect cells in the table and probabilities of the detected cells indicating whether the cells correspond to table headers. Given this, the machine learning model receives the document including the table, and outputs detected cells in the table and a probability assigned to each of the detected cells of representing a table header, e.g., a probability of a detected cell of being a row header or a column header. In one or more implementations, the cells are detected as bounding boxes, i.e., the detected cells have borders or cell boundaries.

The table structure recognition system generates the table structure of the table by performing various rules-based postprocessing algorithms on the model outputs, e.g., the detected cells and the table header probabilities. One or more of the postprocessing algorithms refine the detected cells by removing incorrectly detected cells from the table, inserting additional cells into the table, repositioning cell boundaries of the detected cells, and/or merging overlapping cells. Furthermore, one or more of the postprocessing algorithms generate the table structure by generating rows and columns of the table, assigning detected cells to rows and columns, classifying one or more detected cells as row headers and column headers based on the probabilities, and computing cell span information for the detected cells.

In one or more implementations, table structure recognition system removes one or more incorrectly detected cells from the document. By way of example, the machine learning model additionally outputs an object probability for each of the detected cells. An object probability of a respective cell is a likelihood that the cell represents either a table in the document or a cell of the table. The table structure recognition system removes one or more of the detected cells having an object probability that falls below a threshold.

In various implementations, the table structure recognition system inserts one or more additional cells into the document. To do so, the table structure recognition system groups the detected cells into estimated rows and estimated columns based on positional coordinates of the detected cells. Furthermore, the table structure recognition system identifies gaps between adjacent estimated rows and/or between adjacent estimated columns that exceed a threshold distance. Notably, gaps are portions of the table that are devoid of and/or external to detected cells, e.g., the gaps do not include detected cells. Moreover, the table structure recognition system inserts one or more additional cells to fill the gaps.

In one or more example implementations, the table structure recognition system generates rows and columns of the table, and assigns the detected cells to the generated rows and columns based on positional coordinates of cell boundaries of the detected cells. For example, the table structure recognition system assigns a group of cells to a particular row based on the cells in the group having top or bottom cell boundaries within a threshold distance of one another. Similarly, the table structure recognition system assigns a group of cells to a particular column based on the cells having left or right cell boundaries within a threshold distance of one another.

Furthermore, the table structure recognition system aligns the cells in the rows and columns. To align the cells assigned in a particular row, for instance, the table structure recognition system aligns the top and bottom cell boundaries of the cells in the particular row along common horizontal axes. Similarly, the table structure recognition system aligns the right and left cell boundaries of the cells in a particular column along common vertical axes to align the cells in the particular column.

Additionally or alternatively, the table structure recognition system identifies gaps between pairs of adjacent cells that are external to and/or devoid of detected cells. In such scenarios, the table structure recognition system repositions a first cell boundary of a first adjacent cell in a pair to coincide with a second cell boundary of a second adjacent cell in the pair, thereby filling the gap.

In one or more implementations, the table structure recognition system identifies pairs of overlapping cells, and removes the overlap of the overlapping cells by merging or separating the overlapping cells. In cell merge scenarios, the table structure recognition system converts a pair of overlapping cells into a single merged cell. In cell separation scenarios, the table structure recognition system repositions a first cell boundary of a first overlapping cell to coincide with a second cell boundary of a second overlapping cell, thereby removing the overlap of the overlapping cells. In other words, the table structure recognition system separates the overlapping cells into two non-overlapping cells.

As part of generating the table structure of the table, the table structure recognition system assigns the refined cells to rows and columns, as mentioned above. Additionally, the table structure recognition system computes, for each of the refined cells, a row span value (e.g., a number of rows that the refined cell spans) and a column span value, e.g., a number of columns that the refined cell spans. Moreover, the table structure recognition system assigns portions of table content (e.g., text, figures, images, and graphics within the table) to corresponding refined cells based on a degree to which the portions of table content overlap with the corresponding refined cells.

Furthermore, the table structure recognition system classifies one or more refined cells as row headers and one or more refined cells as column headers. Classification of a particular refined cell as a row header is based on the table header probability assigned to the particular refined cell as well as the table header probabilities assigned to other cells within the same column as the particular refined cell. Similarly, classification of a particular refined cell as a column header is based on the table header probability assigned to the particular refined cell, as well as the table header probabilities assigned to other cells within the same row as the particular refined cell.

Thus, the described techniques use a machine learning model to directly detect cells in a table, and thereafter, use rules-based postprocessing algorithm(s) to refine the cells and generate the table structure, e.g., which includes the refined cells having been assigned to respective rows and respective columns, a row span and a column span for each of the refined cells, one or more row headers, and one or more column headers. This contrasts with conventional table structure recognition techniques that use machine learning to detect rows and columns in the table, and then aim to derive table cells heuristically and/or algorithmically thereafter. Directly outputting detected cells, as implemented by the described techniques, more accurately captures variability of table layouts which improves accuracy in the detected table structure information, as compared to conventional techniques. The various cell refinement postprocessing techniques remove overlapping cells, remove incorrectly detected cells, fill gaps in a table by inserting additional cells or repositioning cell boundaries to coincide with adjacent cell boundaries and/or table boundaries, and the like, which further improves table structure detection accuracy.

Unlike conventional techniques which use machine learning models to output some, but not all, types of table headers (e.g., exterior row headers along the table perimeter, exterior column headers along the table perimeter, interior column headers nested within the table, and interior row headers nested within the table), the described techniques generate a probability for each detected cell of corresponding to a table header. By doing so, the described techniques more accurately detect table headers of all types, e.g., both exterior and interior row and column headers. Finally, unlike various conventional table structure recognition techniques which employ various different models for different structure detection tasks (e.g., line detection, document element segmentation, grid pattern detection, cell merge operations, etc.), the described techniques employ just one machine learning model and refine model outputs using rules-based algorithms, which decreases table structure extraction latency.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Table Structure Recognition Environment

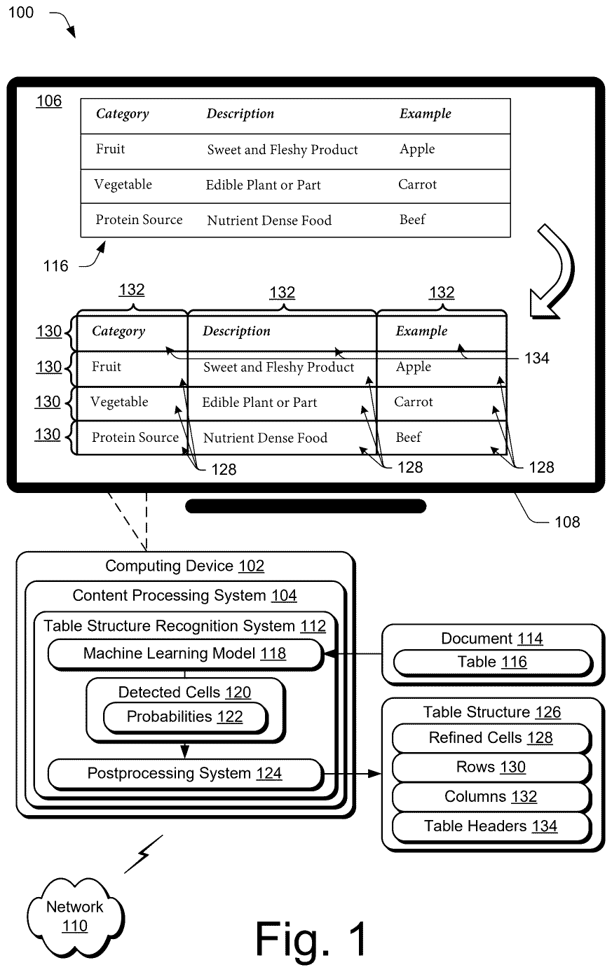

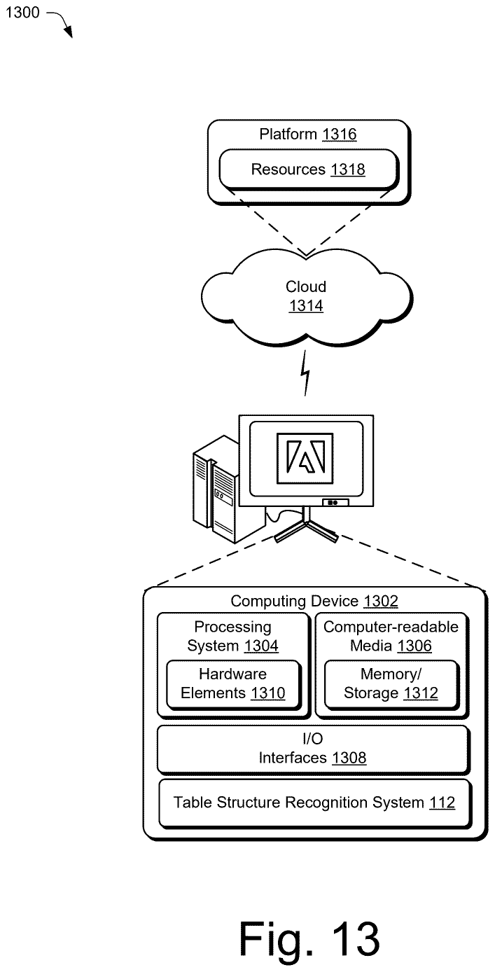

FIG. 1 an illustration of an environment 100 in an example implementation that is operable to employ techniques described herein of table cell detection for table structure recognition. The illustrated environment 100 includes a computing device 102, which is configurable in a variety of ways. The computing device 102, for instance, is configurable as a desktop computer, a laptop computer, a mobile device (e.g., assuming a handheld configuration such as a tablet or mobile phone as illustrated), and so forth. Thus, the computing device 102 ranges from full resource devices with substantial memory and processor resources (e.g., personal computers, game consoles) to a low-resource device with limited memory and/or processing resources (e.g., mobile devices). Additionally, although a single computing device 102 is shown, the computing device 102 is also representative of a plurality of different devices, such as multiple servers utilized by a business to perform operations “over the cloud” as described in FIG. 13.

The computing device 102 is illustrated as including a content processing system 104. The content processing system 104 is implemented at least partially in hardware of the computing device 102 to process and transform digital content. Such processing includes creation of the digital content, modification of the digital content, and rendering of the digital content in a user interface 106 for output, e.g., by a display device 108. Although illustrated as implemented locally at the computing device 102, functionality of the content processing system 104 is also configurable as whole or part via functionality available via the network 110, such as part of a web service or “in the cloud.”

An example of functionality incorporated by the content processing system 104 to process the digital content is illustrated as a table structure recognition system 112. As shown, the table structure recognition system 112 receives, as input, a document 114 (e.g., a portable document format (PDF) document) that includes a table 116. The table 116, for instance, is a structure in the document 114 that is organized into rows and columns of a grid, such that content (e.g., letters, numbers, symbols, images, figures, graphics, and the like) is placed within individual cells of the grid. In various examples, the table 116 is bordered table (e.g., all cells include visible lines defining the boundaries of the cell) or a borderless tables, e.g., there are no cells in the table that include visible lines defining the boundaries of the cell. Alternatively, as shown in the illustrated example, the table 116 is a hybrid table meaning that at least one cell is partially bordered (e.g., includes visible border lines on fewer than all four sides of the cell), and/or some but not all of the cells in the table 116 are fully bordered, e.g., includes visible border lines on all four sides of the cell.

As shown, the document 114 is provided as input to a machine learning model 118, which in one or more implementations, is an object detection model having been trained to output detected cells 120 in the table 116, and assign probabilities 122 to the detected cells 120 of being table headers. Table headers include row headers and column headers. A column header is a cell that provides context with respect to other cells that are within a same column as the column header and positioned vertically with respect to (e.g., above or below) the column header in the table 116. Similarly, a row header is a cell that provides context with respect to other cells that are within a same row as the row header and positioned laterally (e.g., to the right or to the left) with respect to the row header.

Furthermore, the detected cells 120 and the probabilities 122 are provided as input to a postprocessing system 124, which is representative of functionality for generating a table structure 126 of the table 116. As part of this, the postprocessing system 124 refines the detected cells 120 to generate refined cells 128. In FIG. 1 and the remaining figures, red borders are representative of bounding boxes of detected cells 120 or refined cells 128 as output by the table structure recognition system 112, while black borders are representative of borders of the unprocessed table 116 received as input by the table structure recognition system 112. Examples of cell refinement include inserting one or more additional cells, removing one or more incorrectly detected cells 120, merging two or more detected cells 120, and repositioning borders of one or more detected cells 120 to coincide with adjacent cells. As shown, the postprocessing system 124 additionally creates rows 130 and columns 132 in the table 116 by assigning the refined cells 128 to respective rows 130 and columns 132 based on positional coordinates of the refined cells 128. Moreover, the postprocessing system 124 classifies one or more refined cells 128 as table headers 134 (e.g., column headers or row headers) based on the probabilities 122.

Conventional techniques for table structure recognition often use machine learning to detect rows and columns in a table, and then derive cells of the table heuristically. In contrast, the described techniques use machine learning to detect cells of the table 116 directly, and then derive the table structure 126 (e.g., including the refined cells 128, the rows 130, the columns 132, and the table headers 134) using postprocessing techniques. This order of operations (e.g., the model directly outputs detected cells then the postprocessing system generates the table structure by processing the model outputs) improves table structure detection accuracy because direct cell modeling is better suited for handling variability in table layout designs. Furthermore, conventional table structure recognition techniques use machine learning to directly output some, but not all, types of table headers. Different types of table headers include exterior row and column headers along the table perimeter, and interior row and column headers nested within the table. In contrast, the described techniques output header probabilities for each detected cell, which enables more accurate detection of table headers of all types.

### Table Structure Recognition Features

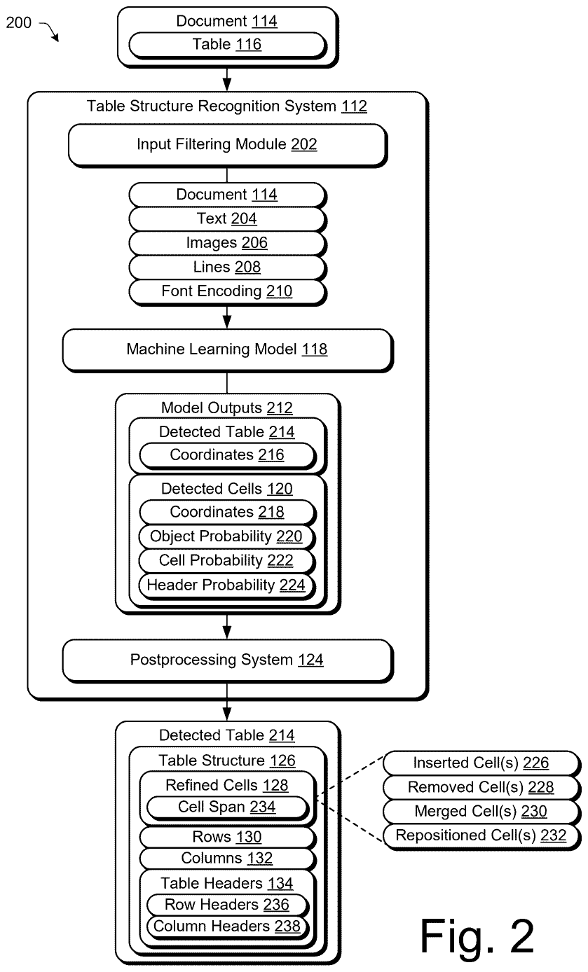

FIG. 2 depicts a system 200 in an example implementation showing operation of a table structure recognition system to generate a table structure for a table in a document. Here, the table structure recognition system 112 receives a document 114 that includes a table 116. In various examples, the document 114 additionally includes at least one non-table element, e.g., non-table elements include all content of the document 114 positioned externally with respect to the table 116. Examples of the non-table element include, but are not limited to including, natural language paragraphs, document headings and subheadings, images, footnotes and endnotes, lists, hyperlinks, and so on. Although examples are described herein in which table structure recognition techniques are performed on a document 114 having a single table 116, it is to be appreciated that the described techniques are extendable to documents 114 having multiple tables 116.

As shown, the document 114 is provided to an input filtering module 202, which is representative of functionality for providing the document 114 to the machine learning model 118 via different input channels. In particular, the input filtering module 202 passes, as a first input channel to the machine learning model 118, the document 114 in its entirety including depictions of all content elements of the document 114. Furthermore, the input filtering module 202 passes, as a second input channel to the machine learning model 118, the document 114 including depictions of just the text 204 (e.g., and excluding other content elements) detected in the document 114. In addition, the input filtering module 202 passes, as a third input channel to the machine learning model 118, the document 114 including depictions of just the images 206 (e.g., and excluding other content elements) detected in the document 114. Moreover, the input filtering module 202 passes, as a fourth input channel to the machine learning model 118, the document 114 including depictions of just the lines 208 (e.g., and excluding other content elements) detected in the document 114.

Furthermore, the input filtering module 202 generates a font encoding 210 representing the font properties of the text in the document 114. In at least one example, the font encoding 210 is a matrix in which each row represents a different text element, and columns represent different font properties. In this context, different text elements include different text blocks contained within different cells of the table, different paragraphs of the document 114, different headings or subheadings of the document 114, and the like. The input filtering module additionally passes, as a fifth input channel to the machine learning model 118, the font encoding 210.

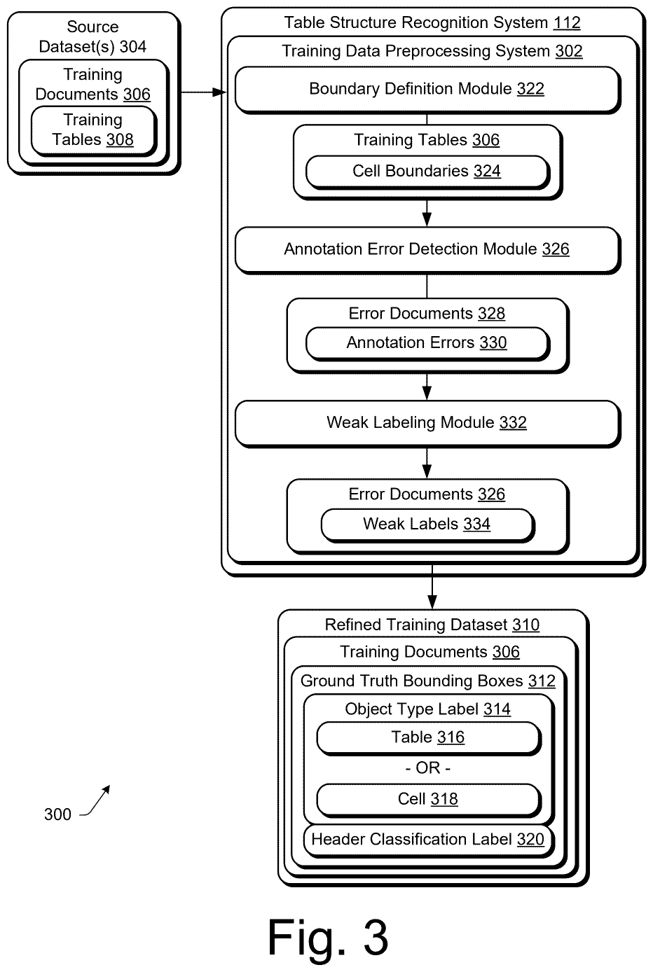

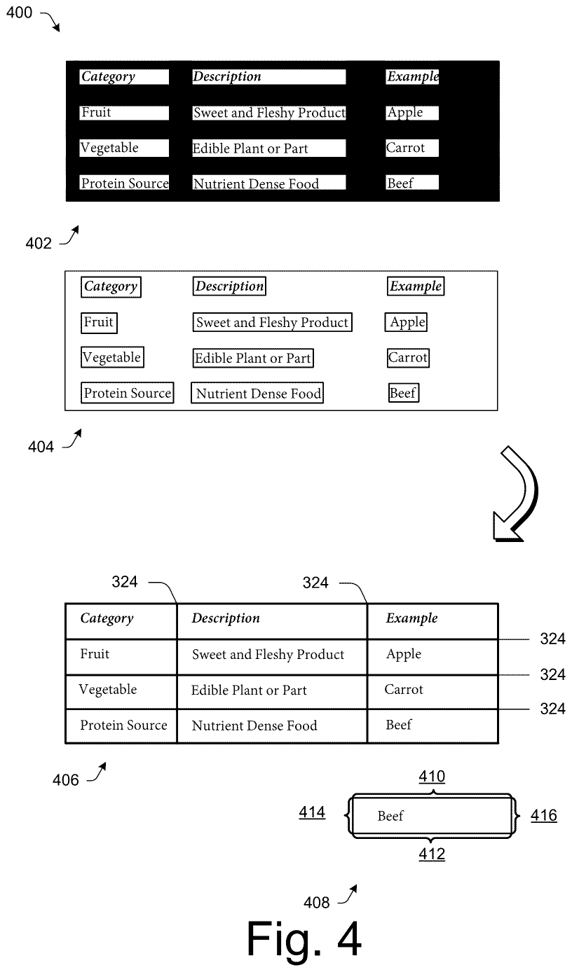

As shown, the machine learning model 118 receives the document 114 via the different input channels, and produces model outputs 212 including a detected table 214 and detected cells 120 in the document 114. In various examples, the machine learning model 118 is an object detection model trained to detect certain objects, which in accordance with the described techniques, are tables and cells of tables. Any one or more of a variety of public or proprietary object detection models are implementable by the table structure recognition system 112, one example of which is a You Only Look Once (YOLO) model, such as a YOLO model or a YOLOX model. As further discussed below with reference to FIG. 3, the machine learning model 118 is trained and/or refined for the task of detecting tables and cells of tables in a document, as well as assigning probabilities to the cells as representing table headers. In variations, the machine learning model 118 is a pre-trained model (e.g., a YOLOX model) that is refined and/or finetuned for the aforementioned task, or the machine learning model 118 is a domain-specific model that is trained from scratch (e.g., starting from uninitialized or randomly initialized parameters) for the aforementioned task.

As used herein, the term “machine learning model” refers to a computer representation that is tunable (e.g., trainable) based on inputs to approximate unknown functions. By way of example, the term “machine learning model” includes a model that utilizes algorithms to learn from, and make predictions on, known data by analyzing the known data to learn to generate outputs that reflect patterns and attributes of the known data. According to various implementations, such a machine learning model uses supervised learning, semi-supervised learning, unsupervised learning, reinforcement learning, continuous learning, interactive learning, and/or transfer learning. For example, a machine learning model is capable of including, but is not limited to including, clustering, decision trees, support vector machines, linear regression, logistic regression, Bayesian networks, random forest learning, dimensionality reduction algorithms, boosting algorithms, artificial neural networks (e.g., fully-connected neural networks, deep convolutional neural networks, or recurrent neural networks), deep learning, etc.

In one or more implementations, the machine learning model detects the objects (e.g., the detected tables 214 and the detected cells 120) as bounding boxes surrounding the detected objects having positional coordinates 216, 218 within the document 114, e.g., coordinates of the cell boundaries or borders of the bounding boxes. As shown, the machine learning model 118 assigns an object probability 220, a cell probability 222, and a header probability 224 to each of the detected cells 120. An object probability 220 is a degree of confidence that a bounding box of a detected cell 120 represents an object, e.g., a table or a cell of a table. A cell probability 222 is a degree of confidence that a bounding box of a detected cell 120 represents a cell of a table rather than the table itself. A header probability 224 is a degree of confidence that a bounding box of a detected cell 120 represents a row header and/or a column header of a table. In one example, the header probability 224 of a detected cell 120 is a degree of confidence that the detected cell 120 represents either a column header or a row header. In at least one alternative example, the header probability 224 of a detected cell 120 includes a row header probability (e.g., a degree of confidence that the detected cell 120 is a row header) and a column header probability, e.g., a degree of confidence that the detected cell is a column header. In various implementations, the header probability 224 of a detected cell 120 is based, at least in part, on the font of text within the detected cell 120, e.g., as encoded in the font encoding.

In accordance with the described techniques, the machine learning model 118 receives the document 114 as input and produces the model outputs 212 with respect to a table 116 without the table 116 having been segmented from the document 114. This contrasts with various conventional techniques that often employ a first machine learning model for segmenting tables from a document, and then employ a second machine learning model for table structure detection, e.g., detection of rows and columns. This not only decreases table structure extraction latency, but enables the described machine learning model 118 to operate in conjunction with a separate document element segmentation model (e.g., a model trained to extract different elements in a document, such as natural language paragraphs, images, figures, tables, and the like) to concurrently segment document elements and generate table structure for the table 116.

As shown, the model outputs 212 are provided to the postprocessing system 124, which is representative of functionality for applying various rules-based algorithms to refine the detected cells 120 and generate a table structure 126 for the detected table 214. In one or more implementations, the postprocessing system 124 refines the detected cells 120 by inserting one or more inserted cells 226 to fill gaps in the detected table 214, e.g., areas that are not covered by the detected cells 120. Additionally or alternatively, the postprocessing system 124 refines the detected cells 120 by removing one or more incorrectly detected cells 120 (i.e., the removed cells 228) based on the object probabilities 220. Additionally or alternatively, the postprocessing system 124 refines the detected cells 120 by merging overlapping detected cells 120, i.e., the merged cells 230. Additionally or alternatively, the postprocessing system 124 refines the detected cells 120 by repositioning borders of the detected cells (i.e., the repositioned cells 232) to align the detected cells 120 in rows and columns, align the detected cells with table boundaries of the detected table 214, remove gaps between adjacent cells, and correct overlapping detected cells.

As part of generating the table structure 126, the postprocessing system 124 calculates cell spans 234 for each of the refined cells 128, e.g., a number of rows and/or a number of columns that a cell extends into. In addition, the postprocessing system 124 generates rows 130 and columns 132 of the detected table 214 by assigning the refined cells 128 to respective rows 130 and columns 132 based on the coordinates 218 of the refined cells 128. Furthermore, the postprocessing system 124 classifies one or more of the refined cells 128 as table headers 134 based on the header probabilities 224. In particular, the postprocessing system 124 classifies a refined cell 128 as a row header 236 based on the header probability 224 of the refined cell 128 and the header probabilities 224 of other refined cells 128 grouped in the same column 132 as the refined cell 128. Similarly, the postprocessing system 124 classifies a refined cell 128 as a column header 238 based on the header probability 224 of the refined cell 128 and the header probabilities of other refined cells 128 grouped in the same row 130 as the refined cell 128.

FIG. 3 depicts a system 300 in an example implementation showing operation of a training data preprocessing system to generate a refined training dataset for training a machine learning model. In the system 300, the table structure recognition system 112 includes a training data preprocessing system 302, which receives one or more source datasets 304. Broadly, the source datasets 304 each include a plurality of training documents 306, and each of the training documents 306 include one or more training tables 308, as shown. Furthermore, the source datasets 304 include table structure data describing structure characteristics of the training tables 308. The one or more source datasets 304 include any one or more of a variety of public or proprietary datasets including table structure information, including but not limited to the PubTables-1M Dataset, described by Smock et. al., in PubTables-1M: Towards Comprehensive Table Extraction from Unstructured Documents (2021), which is hereby incorporated by reference in its entirety.

In one or more implementations, the table structure data of the source datasets 304 includes indications of (e.g., bounding boxes surrounding) the training tables 308, indications of (e.g., bounding boxes surrounding) cells of the training tables 308, indications of (e.g., bounding boxes surrounding) rows and columns in the training tables 308, indications of which rows and which columns respective cells belong to (e.g., row and column indices assigned to cells of the training tables 308), cell span information describing how many and/or which rows and columns that cells of the training tables 308 span, and/or table header information describing which cells in the training tables 308 are table headers, e.g., row headers or column headers. In various implementations, the formatting of the different source datasets 304 is different, such as how cell boundaries of cells and/or bounding boxes are defined, as shown and described below with respect to FIG. 4. Broadly, the training data preprocessing system 302 is configured to generate a refined training dataset 310 based on the table structure data of the source datasets 304 by converting the one or more source datasets 304 to a refined training dataset 310 having a common, unified format.

As shown, the refined training dataset 310 includes, for each of the training documents 306 of the source datasets 304, ground truth bounding boxes 312. Further, each of the ground truth bounding boxes 312 include an object type label 314 indicating whether the ground truth bounding box 312 is a table 316 or a cell 318 of a table. Moreover, each of the ground truth bounding boxes includes a header classification label 320 indicating whether the ground truth bounding box 312 is a table header 134. In some implementations, a header classification label 320 indicates whether a ground truth bounding box 312 identifies a table header 134, but does not identify whether the table header 134 is a row header 236 or a column header 238, e.g., the ground truth bounding box 312 includes a Boolean indicator of whether the bounding box identifies a table header 134. Additionally or alternatively, a header classification label 320 indicates whether a ground truth bounding box 312 identifies a row header 236 or a column header 238, e.g., the ground truth bounding box includes a first Boolean indicator of whether the bounding box identifies a row header 236 and a second Boolean indicator of whether the bounding box identifies a column header 238.

In one or more implementations, the training data preprocessing system 302 employs a boundary definition module 322 to redefine cell boundaries 324 of the training tables 308 in the source datasets 304 to have a consistent formatting. FIG. 4 depicts an example 400 of consistent table boundaries being defined by the training data preprocessing system. In particular, the example 400 includes tables 402, 404 of the source datasets 304 having inconsistently defined cell boundaries.

For instance, the table 402 has cell boundaries defined by a first source dataset 304, while the table 404 has cell boundaries defined by a second source dataset 304. In the table 402, the cell boundaries are defined as boundary regions. For example, a boundary region between two columns is a distance between text elements in adjacent columns, while a boundary region between two rows is a distance between text elements in adjacent rows, as shown. In other words, the boundary region between adjacent rows and adjacent columns encapsulates a maximum amount of whitespace without overlapping text content in the adjacent rows and adjacent columns. In contrast, the cell boundaries of the table 404 are defined as tight bounding boxes, e.g., a bounding box enclosing a portion of text is tight with respect to the enclosed portion of text. In other words, the bounding box is just large enough to enclose the portion of text while minimizing whitespace within the bounding box, and there are gaps between adjacent bounding boxes.

Here, the boundary definition module 322 is configured to convert the cell boundaries of the tables 402, 404 to coincident cell boundaries 324. As shown in the table 406, the coincident cell boundaries 324 of adjacent cells coincide with one another. In the illustrated example 400, for instance, the bottom cell boundary 324 of the bounding box surrounding the text element “Category” coincides with the top cell boundary 324 of the bounding box surrounding the text element “Fruit. ” Similarly the right cell boundary 324 of the bounding box surrounding the text element “Category” coincides with the left cell boundary 324 of the bounding box surrounding the text element “Description.” Notably, as shown at 408, each cell (e.g., detected cell 120 or refined cell 128) includes a top cell boundary 410, a bottom cell boundary 412, a left cell boundary 414, and a right cell boundary 416. Further, the terms “cell boundary” and “border” are used interchangeably herein.

In scenarios in which a training table 308 of a training document 306 includes visible borders between rows and columns of the training table 308 (e.g., the training table 308 is a bordered table or a hybrid table), the boundary definition module 322 defines the cell boundaries 324 in accordance with the visible borders. As part of this, the boundary definition module 322 employs a line detection algorithm to detect orthogonal (e.g. vertical and horizontal) lines in the training document 306. Any one or more of a variety of public or proprietary line detection algorithms are employable by the boundary definition module 322, including but not limited to, computer vision algorithms (e.g., a Hough Transforms Algorithm, Canny Edge Detection Algorithm, a Line Segment Detector (LSD) Algorithm, and so on) and machine learning algorithms, e.g., a DeepEdge Model and a HoughNet model.

If a visible vertical line is detected between two adjacent columns of table content, then the visible vertical line is selected as representing cell boundaries 324 for cells within the two adjacent columns. If a visible horizontal line is detected between two adjacent rows of table content, then the visible horizontal line is selected as representing cell boundaries 324 for cells within the two adjacent rows. All visible orthogonal (e.g., vertical or horizontal) lines detected between adjacent rows or columns are similarly selected as cell boundaries 324 for the cells of the training document 306.

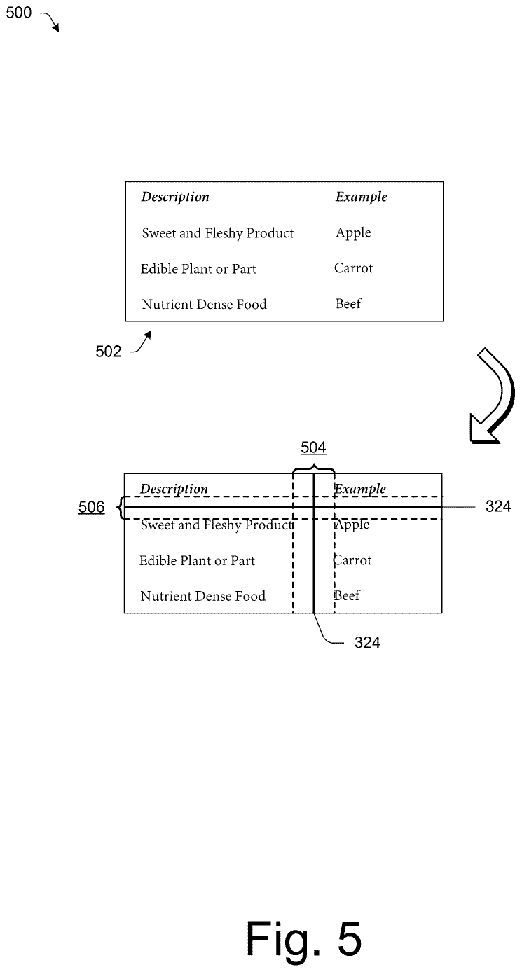

In scenarios in which a training table 308 of a training document 306 does not include visible borders rows and columns of the training table 308 (e.g., the training table 308 is a borderless table or a hybrid table), the boundary definition module 322 defines the cell boundaries 324 based on an amount of whitespace between adjacent rows and columns. FIG. 5 depicts an example 500 of table boundaries of a borderless table being defined by a training data preprocessing system. As shown, the example 500 includes a borderless table 502, e.g., a training table 308. To define a boundary between two adjacent columns of table content, in the example 500, the boundary definition module 322 determines an amount of whitespace 504 between the two adjacent columns. Here, the whitespace 504 is a distance between a rightmost portion of table content in a left adjacent column of the two adjacent columns and a leftmost portion of table content in a right adjacent column of the two adjacent columns. Moreover, the boundary definition module 322 defines cell boundaries 324 as a vertical line in the table at a midpoint of the whitespace 504.

Similarly, to define a boundary between two adjacent rows of table content, the boundary definition module 322 determines an amount of whitespace 506 between the two adjacent rows. Here, the whitespace 506 is a distance between a lowermost portion of table content in an upper adjacent row of the two adjacent rows and an uppermost portion of table content in a lower adjacent row of the two adjacent rows. Further, the boundary definition module 322 defines cell boundaries 324 as a horizontal line in the table at a midpoint of the whitespace 506. Notably, the cell boundaries 324 defined by the boundary definition module 322 correspond to the boundaries of the ground truth bounding boxes 312 enclosing cell objects or table cell objects.

Returning to FIG. 3, an annotation error detection module 326 is configured to detect error documents 328 that include annotation errors 330. To do so, the annotation error detection module 326 analyzes the training documents 306 including the training tables 308 and the redefined cell boundaries 324. As part of this, the annotation error detection module 326 detects training documents 306 with training tables 308 having overlapping cells (e.g., training tables 308 in which at least a portion of table content is enclosed by multiple different ground truth bounding boxes 312), and adds the detected training documents 306 to the list of error documents 328.

Additionally, the annotation error detection module 326 detects training documents 306 having training tables 308 with ground truth bounding boxes 312 that are intersected by visible (e.g., horizontal or vertical) orthogonal lines. To do so, the annotation error detection module 326 employs the aforementioned line detection algorithm to detect visible orthogonal lines in the training documents 306. If at least one ground truth bounding box 312 of a training table 308 within a training document 306 is intersected by a visible orthogonal line, then the training document 306 is added to the list of error documents 328. In one or more implementations, the ground truth bounding boxes 312 are inset (e.g., shrunk) by a predetermined amount before determining whether the ground truth bounding boxes 312 are intersected by the visible orthogonal lines. By doing so, the annotation error detection module 326 prevents adding training documents 306 to the list of error documents 328 if a visible orthogonal line passes very closely to the cell boundaries 324.

As shown, the error documents 328 are provided as input to a weak labeling module 332 configured to assign weak labels 334 to ground truth bounding boxes within the error documents 328. To do so in one or more implementations, the weak labeling module employs an additional machine learning model that is pre-trained to detect table structure information (e.g., rows and columns) in tables. Any of a variety of public or proprietary table structure recognition models are employable by the training data preprocessing system, examples of which include a Table-Transformer (TATR) model and a Deep Learning for Detection and Structure Recognition of Tables in Document Images (DeepDeSRT) model.

Here, an error document 328 is provided to the additional machine learning model, which outputs table structure information, e.g., rows and tables of the training tables 308 in the error document 328. Furthermore, the training data preprocessing system 302 computes ground truth bounding boxes 312 surrounding table cell objects and table objects in the training tables 308 of the error document 328. Further, the training data preprocessing system 302 assigns weak labels 334 to the bounding boxes. The weak labels include object type labels 314 indicating whether the bounding boxes 312 identify table 316 objects or table cell 318 objects, and header classification labels 320 whether the bounding boxes correspond to table headers.

As a result, the training data preprocessing system 302 outputs the refined training dataset 310. For training documents 306 not added to the list of error documents 328, the ground truth bounding boxes 312 correspond to the cell boundaries 324 defined by the boundary definition module 322. Furthermore, the object type labels 314 and the header classification labels 320 are derived from the table structure data of the training document 306 associated with the source dataset. For the error documents, the ground truth bounding boxes 312 are computed based on table structure information as output by the additional machine learning model, and the object type labels 314 and the header classification labels 320 are generated and assigned as weak labels 334 by the weak labeling module 332.

In one or more implementations, the machine learning model is trained using supervised learning. As part of this, the machine learning model 118 receives a training document 306 of the refined training dataset 310, and generates the model outputs 212 based on the training document 306. Here, the model outputs 212 include predicted bounding boxes surrounding objects (e.g., detected tables 214 and detected cells 120) in the training document 306, as well as the cell probability 222 and the header probability 224 assigned to each of the detected objects.

Given a training document, a loss is computed using a loss function. The loss captures positional distances between the predicted bounding boxes and corresponding ground truth bounding boxes 312. Additionally or alternatively, the loss captures a difference between the cell probability 222 of predicted bounding boxes (e.g., measured on a scale from zero to one) and the object type label 314 (e.g., table 316 objects are labeled with zero and table cell 318 objects are labeled with one) of corresponding ground truth bounding boxes 312. Additionally or alternatively, the loss captures a difference between the header probability 224 (e.g., measured on a scale from zero to one) of the predicted bounding boxes and the header classification label 320 (e.g., non-header cells are labeled with zero and header cells are labeled with one) of corresponding ground truth bounding boxes 312.

Parameters (e.g., internal weights) of the machine learning model are updated to reduce the loss. In one or more implementations, the parameters of the machine learning model 118 are updated to a lesser degree for error documents 328 including the weak labels 334 than training documents 306 that are not added to the list of error documents 328. Additionally or alternatively, there is no difference in how the model is updated for the error documents 328 and the training documents 306 that are not added to the list of error documents 328. The above-described process is repeated on different training documents 306 until the loss converges to a minimum, a minimum number of training document 306 have been processed, or a minimum number of epochs have been processed, resulting in a trained machine learning model 118.

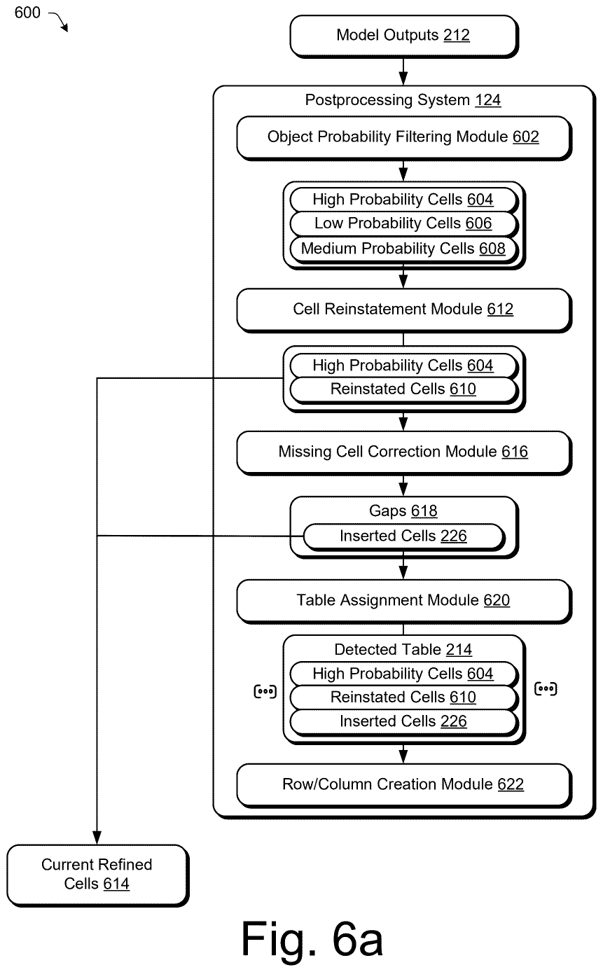

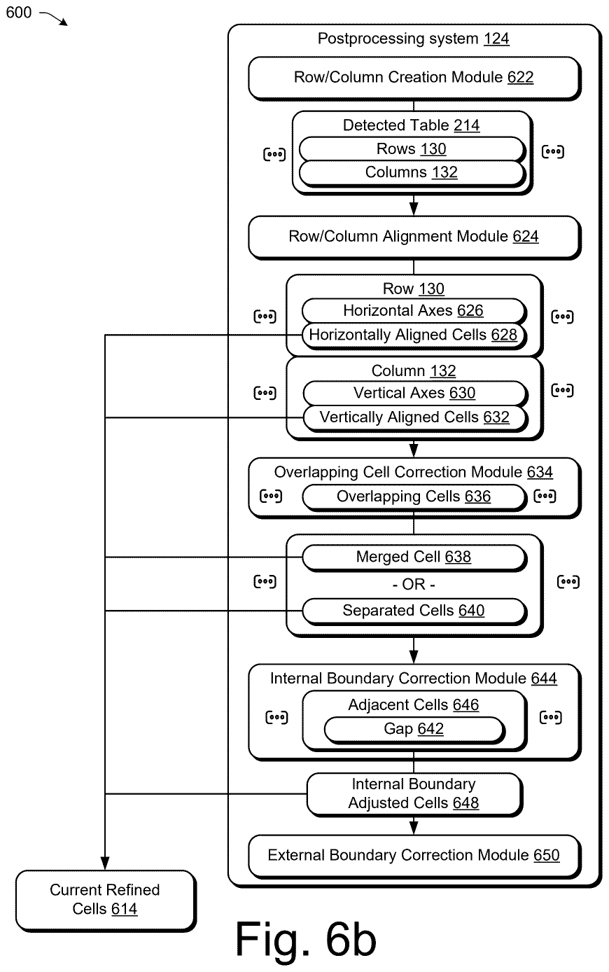

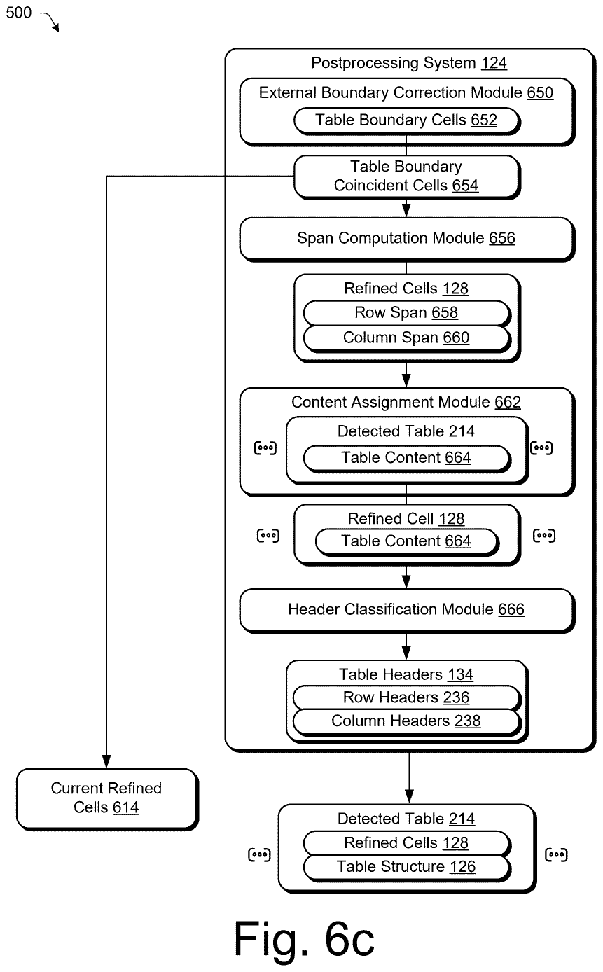

FIGS. 6a-6c depict a system 600 in an example implementation showing operation of a postprocessing system to process model outputs of a machine learning model to generate table structures for one or more tables in a document. As shown, the postprocessing system 124 receives the model outputs 212 generated by the machine learning model 118. As previously discussed with reference to FIG. 2, the model outputs 212 include a detected table 214 and coordinates 216 thereof as well as detected cells 120 and coordinates 218 thereof. In addition, each of the detected cells 120 includes an object probability 220 (e.g., a degree of confidence that the detected cell 120 is a table object or a cell object), a cell probability 222 (e.g., a degree of confidence that the detected cell 120 is a cell object rather than a table object), and a header probability 224, e.g., a degree of confidence that the detected cell is a row header or a column header.

An object probability filtering module 602 is configured to categorize the detected cells 120 as high probability cells 604, low probability cells 606, and medium probability cells 608 based on the object probabilities 220. By way of example, the object probability filtering module 602 categorizes, as high probability cells 604, detected cells 120 assigned an object probability 220 above a first threshold, e.g., 0.3 or thirty percent. Further, the object probability filtering module 602 categorizes, as low probability cells 606, detected cells 120 assigned an object probability 220 below a second threshold that is less than the first threshold, e.g., 0.03 or three percent. Finally, the object probability filtering module 602 categorizes, as medium probability cells 608, detected cells 120 assigned an object probability 220 above the second threshold but below the first threshold, e.g., between 0.03 and 0.3 or between three and thirty percent.

Furthermore, the object probability filtering module 602 permanently removes the low probability cells 606, and conditionally removes the medium probability cells 608. The medium probability cells 608 are conditionally removed in the sense that one or more medium probability cells 608 are reinstated as reinstated cells 610 by the cell reinstatement module 612 if certain conditions are met. For example, the cell reinstatement module identifies a portion of table content (e.g., text) that is within the detected table 214, but external to the high probability cells 604. In other words, the portion of table content is not enclosed by any high probability cells 604. Furthermore, the cell reinstatement module 612 identifies a medium probability cell 608 that originally contained the portion of the table content prior to being conditionally removed, and reinstates the medium probability cell 608 as a reinstated cell 610. This process is optionally repeated for a plurality of table content portions sitting external to the high probability cells 604, resulting in a plurality of reinstated cells 610. Accordingly, a reduced subset of the detected cells 120 are kept (e.g., the high probability cells 604 and the reinstated cells 610) while one or more medium probability cells 608 and low probability cells 606 are discarded.

As shown, the reinstated cells 610 and the high probability cells 604 make up a set of current refined cells 614. The current refined cells 614 are the refined cells 128 as processed up to a current point in the postprocessing workflow, and the current refined cells 614 are used for one or more downstream postprocessing steps and/or processes. Here, the current refined cells 614 (e.g., including the high probability cells 604 and the reinstated cells 610) are provided as input to a missing cell correction module 616.

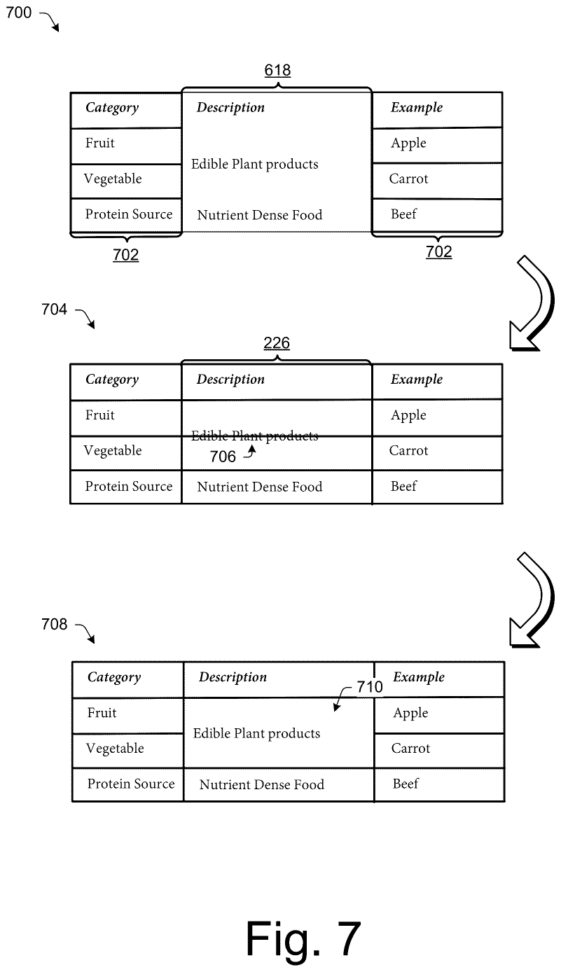

The missing cell correction module 616 is configured to identify gaps 618 in the detected table 214 that are external to the set of current refined cells 614, and insert one or more additional cells (e.g., the inserted cells 226) to fill the gaps 618. In one or more implementations, the missing cell correction module 616 additionally identifies a portion of table content of the detected table 214 that spans two or more of the inserted cells 226, and merges the two or more inserted cells 226. An example of this functionality is described below with reference to FIG. 7.

FIG. 7 depicts an example 700 of a postprocessing technique to insert additional cells and merge the additional cells. In the example 700, the missing cell correction module 616 groups the current refined cells 614 into estimated columns 702 based on the coordinates 218 of the current refined cells 614. Furthermore, the missing cell correction module 616 identifies a gap 618 (e.g., an area of the detected table 214 that is external to the current refined cells 614) between adjacent estimated columns 702, as shown. In one or more implementations, the gap 618 is detected as at least a threshold distance separating the two adjacent columns 702. As shown at 704, the missing cell correction module 616 inserts a new column of cells (e.g., the inserted cells 226) to fill the gap 618. As shown, the inserted cells 226 include vertical cell boundaries corresponding to the vertical cell boundaries of the cells in the two adjacent estimated columns 702. Furthermore, the inserted cells 226 include horizontal cell boundaries that are extensions of the horizontal cell boundaries of the cells in the two adjacent estimated columns 702.

Further, the missing cell correction module 616 additionally identifies a portion of table content 706 (e.g., the text block “edible plant products”) that spans (e.g., crosses cell boundaries of) two or more of the inserted cells 226. As shown at 708, the missing cell correction module 616 merges the two or more inserted cells 226, resulting in a merged cell 710. This process is optionally repeated on a plurality of gaps 618 between adjacent estimated columns.

Although the missing cell correction process is described above with reference to a gap 618 between two adjacent estimated columns 702, a similar process is implementable by the missing cell correction module 616 to fill gaps 618 between two adjacent estimated rows. For instance, the missing cell correction module 616 groups the current refined cells 614 into estimated rows based on the coordinates, and identifies gaps 618 between adjacent estimated rows that are greater than a threshold distance. Furthermore, the missing cell correction module 616 inserts one or more new rows of cells (e.g., the inserted cells 226) to fill the gaps 618 between adjacent estimated rows. Moreover, the missing cell correction module 616 identifies a portion of table content that spans (e.g., crosses cell boundaries of) two or more of the inserted cells 226, and merges the two or more inserted cells 226.

Returning to FIG. 6a, the inserted cells 226 are added to the current refined cells 614, and as such, the current refined cells 614 include the high probability cells 604, the reinstated cells 610, and the inserted cells 226 for one or more downstream postprocessing steps. In particular, a table assignment module 620 is configured to assign the current refined cells 614 to respective detected tables 214 based on the coordinates 218 of the current refined cells 614. To do so, the table assignment module 620 assigns to a respective detected table 214, each current refined cell 614 having at least a threshold percentage (e.g., ten percent) of its geometric area contained within the respective detected table 214. In scenarios in which multiple detected tables 214 are detected in a document 114, this process is repeated for each detected table 214 in the document 114. Once a cell is assigned to a detected table 214 it is removed from consideration for assignment to other detected tables 214. In other words, each cell of the current refined cells 614 is assigned to, at most, one detected table 214. As a result, the table assignment module 620 outputs one or more detected tables 214 having one or more high probability cells 604, one or more reinstated cells 610, and/or one or more inserted cells 226 assigned thereto.

Referring now to FIG. 6b, a row/column creation module 622 is configured to generate rows 130 and columns 132 of a detected table 214 by assigning groups of the current refined cells 614 to the rows 130 and the columns 132 based on the coordinates 218 of the current refined cells 614. To generate rows 130 of a detected table 214, the row/column creation module 622 identifies a minimum height value among the current refined cells 614 of the detected table 214, e.g., a current refined cell 614 exhibiting a shortest distance from its top cell boundary coordinate 218 to its bottom cell boundary coordinate 218.

Furthermore, the row/column creation module 622 generates a row 130 and initializes the row 130 with a first cell of the detected table 214. The first cell has a first top cell boundary coordinate 218 and a first bottom cell boundary coordinate 218. In addition, the row/column creation module 622 assigns additional cells of the detected table 214 to the row 130 having top cell boundary coordinates 218 within a threshold distance of the first top cell boundary coordinate 218. Additionally or alternatively, the row/column creation module 622 assigns additional cells of the detected table 214 to the row 130 having bottom cell boundaries within a threshold distance of the first bottom cell boundary. In one or more implementations, the threshold distance is a function (e.g., a percentage, such as seventy-five percent) of the minimum height value. As a result, a group of cells are assigned to the row 130, and the group of cells have top cell boundaries or bottom cell boundaries within a threshold distance of one another.

A similar process is implemented by the row/column creation module 622 to generate columns 132 of the detected table 214. For instance, the row/column creation module 622 identifies a minimum width value among the current refined cells 614 assigned to the detected table 214, e.g., a current refined cell 614 exhibiting a shortest distance from its left cell boundary coordinate 218 to its right cell boundary coordinate 218. Furthermore, the row/column creation module 622 generates a column 132 and initializes the column 132 with a first cell of the detected table 214. The first cell has a first left cell boundary coordinate 218 and a first right cell boundary coordinate 218. In addition, the row/column creation module 622 assigns additional cells of the detected table 214 to the column 132 having left cell boundary coordinates 218 within a threshold distance of the first left cell boundary coordinate 218. Additionally or alternatively, the row/column creation module 622 assigns additional cells of the current refined cells 614 to the column 132 having right cell boundary coordinates 218 within a threshold distance of the first right cell boundary coordinate 218. In one or more implementations, the threshold distance is a function (e.g., a percentage, such as seventy-five percent) of the minimum width value. As a result, a group of cells are assigned to the column 132, and the group of cells have left cell boundaries or right cell boundaries within a threshold distance of one another.

The aforementioned row/column creation process is repeated iteratively to generate a plurality of rows 130 and a plurality of columns 132 in the detected table 214. In scenarios in which multiple detected tables 214 are detected in the document 114, the row/column creation process is repeated iteratively for each of the multiple detected tables 214.

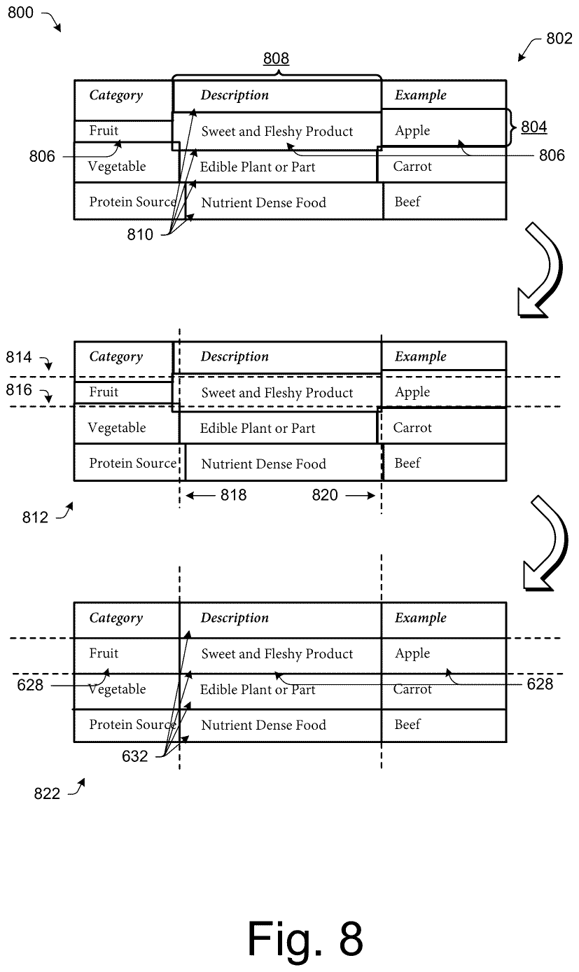

A row/column alignment module 624 receives the detected tables 214 having the generated rows 130 and columns 132 with the current refined cells 614 assigned thereto. The row/column alignment module 624 is configured to reposition the cell boundaries of the current refined cells 614 assigned to a respective row 130 along common horizontal axes 626, resulting in horizontally aligned cells 628. Similarly, the row/column alignment module 624 is configured to reposition the cell boundaries of the current refined cells 614 assigned to a respective column 132 along common vertical axes 630, resulting in vertically aligned cells 632. An example of this functionality is described below with reference to FIG. 8.

FIG. 8 depicts an example 800 of a postprocessing technique to reposition detected cells within rows and columns along common axes. As shown at 802, a detected table 214 includes a row 804 that is assigned cells 806 enclosing respective text blocks “fruit,” “sweet and fleshy product,” and “apple.” In addition, the detected table 214 includes a column 808 that is assigned cells 810 enclosing respective text blocks “description,” “sweet and fleshy product,” “edible plant or part,” and “nutrient dense food.” In the example 800, the row/column alignment module 624 is configured to align the cell boundaries of the cells 806, 810 in the row 804 and the column 808, respectively.

As part of aligning the cells 806 in the row 804, the row/column alignment module 624 calculates an average (e.g., median or mean) top value of the top boundary coordinates 218 of the cells 806 in the row 804, an average (e.g., median or mean) bottom value of the bottom boundary coordinates 218 of the cells 806 in the row 804, and a minimum cell height value for the row 804, e.g., a cell 806 in the row 804 exhibiting a shortest distance from its top cell boundary coordinate 218 to its bottom cell boundary coordinate 218. Similarly, as part of aligning the cells 810 in the column 808, the row/column alignment module 624 calculates an average (e.g., median or mean) left value of the left boundary coordinates 218 of the cells 810 in the column 808, an average (e.g., median or mean) right value of the right boundary coordinates 218 of the cells 810 in the column 808, and a minimum cell width value for the column 808, e.g., a cell 810 in the column 808 exhibiting a shortest distance from its left cell boundary coordinate 218 to its right cell boundary coordinate 218.

Further, as shown at 812, the row/column alignment module 624 is configured to identify a top horizontal axis 814 and a bottom horizontal axis 816 for the row 804. To do so, the row/column alignment module 624 employs the aforementioned line detection algorithm to identify visible horizontal lines in the detected table 214, e.g., visible horizontal lines that were present in the table 116 as originally received as input by the table structure recognition system 112. If a visible horizontal line is detected within a threshold distance of the average top value, the visible horizontal line is selected as the top horizontal axis 814 for the row 804, e.g., the top horizontal axis 814 coincides with the visible horizontal line. Similarly, if a visible horizontal line is detected within a threshold distance of the average bottom value, the visible horizontal line is selected as the bottom horizontal axis 816 for the row 804, e.g., the bottom horizontal axis 816 coincides with the horizontal visible line. In one or more implementations, the threshold distance is a function (e.g., a percentage, such as twenty-five percent) of the minimum cell height value for the row 804.

If no visible horizontal lines are detected within the threshold distance of the average top value, then the top horizontal axis 814 is generated at the average top value of the top boundary coordinates 218 of the cells 806 in the row 804. If no visible horizontal lines are detected within the threshold distance of the average bottom value, then the bottom horizontal axis 816 is generated at the average bottom value of the bottom boundary coordinates 218 of the cells 806 in the row 804.

The row/column alignment module 624 similarly identifies a left horizontal axis 818 and a right horizontal axis 820, as shown at 812. To do so, the row/column alignment module 624 employs the aforementioned line detection algorithm to identify visible vertical lines in the detected table 214, e.g., visible vertical lines that were present in the table 116 as originally received as input by the table structure recognition system 112. If a visible vertical line is detected within a threshold distance of the average left value, the visible vertical line is selected as the left vertical axis 818 for the column 808, e.g., the left vertical axis 818 coincides with the visible vertical line. Similarly, if a visible vertical line is detected within a threshold distance of the average right value, the visible vertical line is selected as the right vertical axis 820 for the column 808, e.g., the right vertical axis 820 coincides with the visible vertical line. In one or more implementations, the threshold distance is a function (e.g., a percentage, such as twenty-five percent) of the minimum cell width value for the column 808.

If no visible vertical lines are detected within the threshold distance of the average left value, then the left vertical axis 818 is generated at the average left value of the left boundary coordinates 218 of the cells 810 in the column 808. If no visible vertical lines are detected within the threshold distance of the average right value, then the right vertical axis 820 is generated at the average right value of the right boundary coordinates 218 of the cells 810 in the column 808.

As shown at 822, the row/column alignment module 624 repositions top cell boundaries of the cells 806 in the row 804 to coincide with the top horizontal axis 814, and repositions bottom cell boundaries of the cells 806 in the row 804 to coincide with the bottom horizonal axis 816, resulting in the horizontally aligned cells 628. Moreover, the row/column alignment module 624 repositions left cell boundaries of the cells 810 in the column 808 to coincide with the left vertical axis 818, and repositions right cell boundaries of the cells 810 in the column 808 to coincide with the right vertical axis 820, resulting in the vertically aligned cells 632.

Although not depicted, in one or more implementations, the row/column alignment module 624 refrains from repositioning a top or bottom cell boundary of a particular cell 806 in the row 804 if the top or bottom cell boundary is not within a threshold distance (e.g., a percentage of the minimum cell height of the row 804) of the average top value or the average bottom value, respectively. Similarly, the row/column alignment module 624 refrains from repositioning a left or right cell boundary of a particular cell 810 in the column 808 if the left or right cell boundary is not within a threshold distance (e.g., a percentage of the minimum cell width of the column 808) of the average left value or the average right value, respectively. This process is repeated iteratively for different rows 130 and different columns 132 of the detected table 214, as well as for different detected tables 214, in various implementation scenarios.

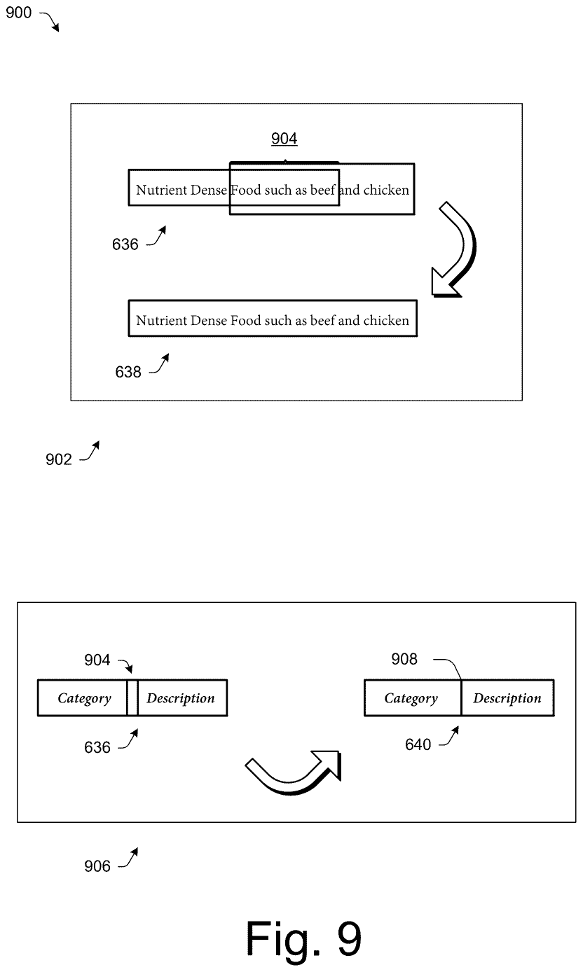

Returning to FIG. 6b, the current refined cells 614 are modified to include the horizontally aligned cells 628 and the vertically aligned cells 632, as shown. Furthermore, an overlapping cell correction module 634 is configured to identify pairs of overlapping cells 636 of the current refined cells 614. In one or more implementations, the overlapping cell correction module 634 corrects a respective pair of overlapping cells 636 by merging the overlapping cells 636, resulting in a single merged cell 638 formed from the pair of overlapping cells 636. Additionally or alternatively, the overlapping cell correction module 634 corrects a respective pair of overlapping cells 636 by separating the overlapping cells 636, resulting in a pair of separated cells 640 having repositioned cell boundaries to remove the overlap of the overlapping cells 636. A determination of whether to separate or merge a respective pair of overlapping cells 636 is based on a degree of overlap between the overlapping cells 636 and cell boundary coordinates 218 of surrounding cells adjacent to the overlapping cells 636. An example of this functionality is described below with respect to FIG. 9.

FIG. 9 depicts an example 900 of a postprocessing technique to merge or separate overlapping cells. In a first example 902, a pair of overlapping cells 636 are merged to form a merged cell 638. Here, the overlapping cell correction module 634 identifies an overlap 904 of the overlapping cells 636, and calculates an amount of overlap of the overlapping cells. In accordance with the described techniques, the overlapping cell correction module 634 merges the overlapping cells 636 based on the amount of overlap exceeding a threshold. In the case of overlapping cells 636 detected in a same row 130 (as shown in the first example 902), the threshold is a function (e.g., a percentage) of the minimum cell width among cells in the row 130. In the case of overlapping cells 636 detected in a same column 132 (not depicted), the threshold is a function (e.g., a percentage) of the minimum cell height among cells in the column.

In accordance with the described techniques, the overlapping cell correction module 634 merges the overlapping cells 636 based on cell boundaries of cells adjacently surrounding the overlapping cells 636. In the case of overlapping cells 636 detected within a particular row 130 (as shown in the depicted example), the overlapping cells 636 are merged if adjacent row(s) 130 above and/or below the overlapping cells 636 do not include a vertical cell boundary within the overlap 904 area. In the case of overlapping cells 636 detected within a particular column 132 (not depicted), the overlapping cells 636 are merged if adjacent column(s) 132 positioned laterally with respect to the particular column do not include a horizontal cell boundary within the overlap area. In other words, overlapping cells 636 are merged if the amount of overlap of the overlapping cells 636 exceeds a threshold (e.g., a first condition), or if the cell boundaries of cells adjacently surrounding the overlapping cells occur external to an overlap 904 area of the overlapping cells, e.g., a second condition.

If neither the first condition nor the second condition is satisfied, then the overlapping cell correction module 634 separates the overlapping cells 636 as shown in a second example 906, resulting in a pair of separated cells 640. In the case of overlapping cells 636 detected within a particular row 130 (as depicted in the second example 906), a common vertical cell boundary 908 is defined within the overlap 904 area, and vertical cell boundaries of the overlapping cells 636 are repositioned to coincide with the common vertical cell boundary 908. In the case of overlapping cells 636 detected within a particular column 132 (not depicted), a common horizontal cell boundary is defined within the overlap 904 area, and horizontal cell boundaries of the overlapping cells 636 are repositioned to coincide with the common horizontal cell boundary. This process is repeated for a plurality of pairs of overlapping cells 636 in the detected table 214, and for multiple detected tables in various implementation scenarios.

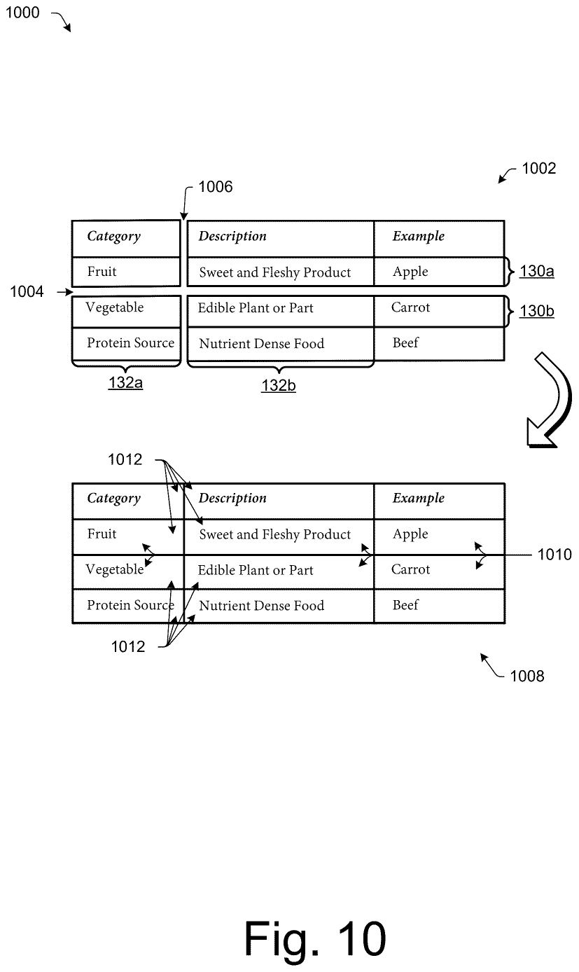

Returning to FIG. 6b, the current refined cells 614 are modified to include the merged cells 638 and/or the separated cells 640, as shown. Notably, in various scenarios, the row/column alignment module 624 detects horizontal axes 626 of adjacent rows 130 that are not coincident and/or vertical axes 630 of adjacent columns 132 that are not coincident, thereby leaving gaps 642 between the adjacent rows 130 and/or adjacent columns 132 that are devoid of the current refined cells 614. An internal boundary correction module 644 is employed to fill these gaps 642. To do so, the internal boundary correction module 644 identifies pairs of adjacent cells 646 of the current refined cells 614 having a gap 642 separating the pair of adjacent cells 646 that is devoid of the current refined cells 614. Further, the internal boundary correction module 644 repositions, for each respective pair of adjacent cells 646, a first border of a first adjacent cell of the pair to coincide with a second border of a second adjacent cell of the pair, resulting in internal boundary adjusted cells 648. After being repositioned, the current refined cells 614 are modified to include the internal boundary adjusted cells 648, as shown. An example of this functionality is shown in FIG. 10.

FIG. 10 depicts an example 1000 of a postprocessing technique to reposition borders of detected cells to coincide with borders of adjacent cells. As shown at 1002, the internal boundary correction module 644 identifies a gap 1004 separating adjacent cells in adjacent rows 130a, 130b, as well as a gap 1006 separating adjacent cells in adjacent columns 132a, 132b. Further, as shown at 1008, the internal boundary correction module 644 repositions the top and/or bottom cell boundaries of the adjacent cells 1010 in the adjacent rows 130a, 130b in a way that causes the bottom cell boundaries of the adjacent cells 1010 in the row 130a to coincide with the top cell boundaries of the adjacent cells 1010 in the row 130b, e.g., to fill the gap 1004. In one or more implementations, the cell boundaries of a pair of vertically adjacent cells 1010 are adjusted if the bottom cell boundary of a first adjacent cell 1010 within a top row 130a of the adjacent rows 130a, 130b is within a threshold distance of the top cell boundary of a second adjacent cell 1010 within a bottom row 130b of the adjacent rows 130a, 130b. In at least one example, the threshold distance is a function (e.g., a percentage, such as twenty percent) of a cell height of one of the vertically adjacent cells in the pair, e.g., a distance from a cell's top boundary to the cell's bottom boundary.

Similarly, the internal boundary correction module 644 repositions the left and/or right cell boundaries of the adjacent cells 1012 in the adjacent columns 132a, 132b in a way that causes the right cell boundaries of the adjacent cells 1012 in the column 132a to coincide with the left cell boundaries of the adjacent cells 1012 in the column 132b, e.g., to fill the gap 1006. In one or more implementations, a pair of laterally adjacent cells 1012 are adjusted if the right cell boundary of a first adjacent cell 1012 within a left column 132a of the adjacent columns 132a, 132b is within a threshold distance of the left cell boundary of a second adjacent cell 1012 within a right column 132b of the adjacent columns 132a, 132b. In at least one example, the threshold distance is a function (e.g., a percentage, such as twenty percent) of a cell width of one of the laterally adjacent cells in the pair, e.g., a distance from a cell's left boundary to the cell's right boundary. The adjacent cells 1010, 1012 having repositioned borders as shown at 1008 represent the internal boundary adjusted cells 648. This process is repeated iteratively to generate internal boundary adjusted cells 648 to fill a plurality of gaps 642 detected between pairs of adjacent cells 646 in a detected table 214, and optionally, for multiple detected tables 214 in a document 114.

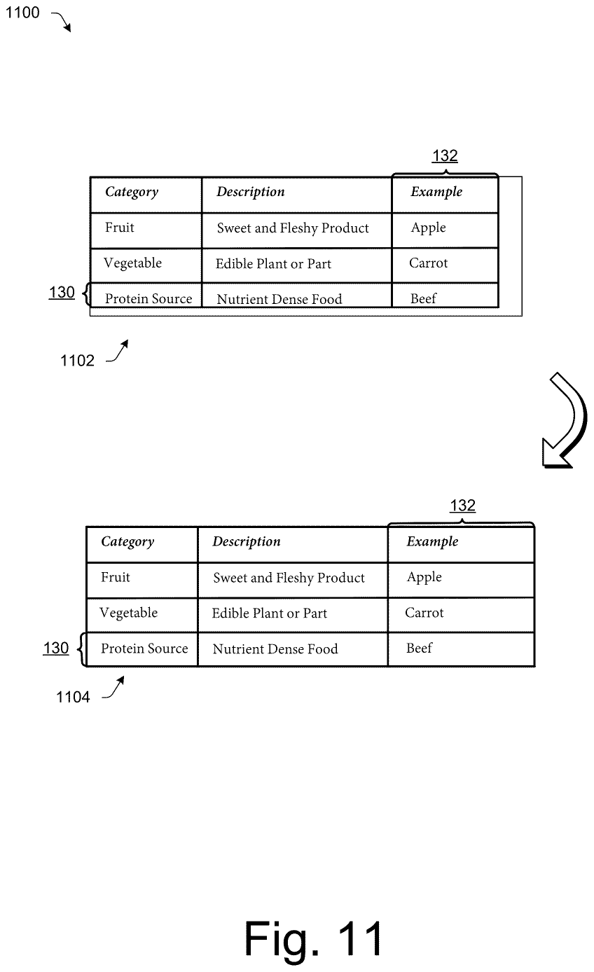

Referring now to FIG. 6c, in various scenarios, the row/column alignment module 624 detects horizontal axes 626 of an uppermost row or a lowermost row in a detected table 214 that do not coincide with the table boundaries of the detected table 214. Furthermore, the row/column alignment module 624 detects vertical axes 630 of a leftmost column 132 or a rightmost column 132 in a detected table 214 that do not coincide with the table boundaries of the detected table 214. Therefore, an external boundary correction module 650 is employed to detect table boundary cells 652 situated along the table boundaries of a detected table 214, e.g., cells in an uppermost row, a lowermost row, a leftmost column, and a rightmost column. Furthermore, the external boundary correction module 650 determines whether the table boundary cells 652 are coincident with the table boundary of the detected table 214 to which the table boundary cells 652 are assigned. If a table boundary cell 652 is not coincident with the table boundary, the external boundary correction module 650 repositions a border of the table boundary cell 652 to be coincident with the table boundary. This process is repeated for all table boundary cells 652 in one or more detected tables 214, resulting in table boundary coincident cells 654. An example of this functionality is described below with respect to FIG. 11.

FIG. 11 depicts an example 1100 of a postprocessing technique to reposition borders of detected cells to coincide with a table boundary of a table. As shown at 1102, bottom cell boundaries of cells within a bottom row 130 of a detected table 214 are not coincident with the table boundaries of the detected table 214, and right cell boundaries of cells within a rightmost column 132 are not coincident with the table boundaries of the detected table 214. Accordingly, as shown at 1104, the bottom cell boundaries of the cells within the bottom row 130 of the detected table 214 are repositioned to be coincident with the table boundaries, and the right cell boundaries of the cells within the rightmost column 132 of the detected table 214 are repositioned to be coincident with the table boundaries.

Returning to FIG. 6c, the current refined cells 614 are modified to include the table boundary coincident cells 654. At this point in the postprocessing workflow, the current refined cells 614 represent the final refined cells 128, as downstream postprocessing steps do not further refine the refined cells 128.

In one or more implementations, a span computation module 656 is employed to compute, for each of the refined cells 128, a row span 658 indicating a number of rows that the refined cell 128 spans, and a column span 660 indicating a number of rows that the refined cell spans. To compute the row span 658 of a refined cell 128 in a detected table 214, the span computation module 656 determines vertical coordinate ranges for each of the rows 130 within the detected table 214. A vertical coordinate range for a row 130 is a difference between the top horizontal axis 626 along which the top cell boundaries of the cells in the row 130 are aligned and the bottom horizontal axis 626 along which the bottom cell boundaries of the cells in the row 130 are aligned. In implementations in which a row 130 includes at least one cell that is not aligned along the common horizontal axes 626 of the row 130, the vertical coordinate range is a difference between the minimum (e.g., positionally lowest) top cell boundary coordinate 218 of the cells in the row 130 and a maximum (e.g., positionally highest) bottom cell boundary coordinate 218 of the cells in the row 130. If the refined cell 128 occupies at least a threshold percentage (e.g., sixty percent) of a vertical coordinate range of a row 130, the refined cell 128 is determined to extend into and/or span the row 130, e.g., the row span 658 value is incremented by one.

To compute the column span 660 of a refined cell 128 in a detected table, the span computation module 656 determines horizontal coordinate ranges for each of the columns 132 within the detected table 214. A horizontal coordinate range for a column 132 is a difference between the left vertical axis 630 along which the left cell boundaries of the cells in the column 132 are aligned and the right vertical axis 630 along which the right cell boundaries of the cells in the column 132 are aligned. In implementations in which a column 132 includes at least one cell that is not aligned along the common vertical axes 630 of the column 132, the horizontal coordinate range is a difference between the maximum (e.g., positionally furthest right) left cell boundary coordinate 218 of the cells in the column 132 and a minimum (e.g., positionally furthest left) right cell boundary coordinate 218 of the cells in the column 132. If the refined cell 128 occupies at least a threshold percentage (e.g., sixty percent) of a horizontal coordinate range of a column 132, the refined cell 128 is determined to extend into and/or span the column 132, e.g., the column span 660 value is incremented by one.

A content assignment module 662 is further configured to assign respective portions of table content 664 (e.g., text, figures, graphics, etc.) of a detected table 214 to corresponding refined cells 128 based on a degree of overlap between the respective portions of table content 664 and the corresponding refined cells 128. Given a portion of table content 664 (e.g., a text block, a figure, a graphic) within a detected table 214, for instance, the content assignment module 662 iteratively computes a degree of overlap of the table content 664 portion with respective refined cells 128. Here, the degree of overlap of a table content 664 portion with respect to a refined cell 128 is a percentage of the table content 664 that is contained within the refined cell 128. If the degree of overlap of the table content 664 portion with respect to a refined cell 128 is above a threshold (e.g., ninety-eight percent), then the table content 664 portion is assigned to the refined cell 128.

If there are no refined cells 128 that overlap the table content 664 portion in accordance with the threshold but the table content 664 portion overlaps at least partially with at least one refined cell 128, then the assignment of the table content 664 portion differs based on whether the table content 664 portion is a text block or graphic/figure content. In scenarios in which the table content 664 portion is graphic/figure content, the table content 664 portion is initially not assigned to any refined cells 128, because it is assumed that the graphic/figure content is likely a background or a table boundary element. In scenarios in which the table content 664 portion is a text block, the text block is assigned to a refined cell 128 having a highest degree of overlap with the text block from among the refined cells 128. Remaining text block table content 664 portions of the detected table 214 are similarly assigned.

If, after the text blocks are assigned, one or more empty refined cells 128 are yet to be assigned any table content 664, then the unassigned graphic/figure content is analyzed for assignment to the one or more refined cells 128. For example, the content assignment module 662 assigns an unassigned graphic/figure table content 664 portion to an empty refined cell 128 having a highest degree of overlap with the graphic/figure table content 664. This process is repeated on the remaining empty refined cells 128 until all refined cells 128 are assigned a portion of the table content 664 or all graphic/figure table content 664 portions are assigned to respective refined cells.

As shown, a header classification module 666 is configured to classify one or more of the refined cells 128 as table headers 134, e.g., row headers 236 or column headers 238. Generally, the header classification module 666 determines whether to classify a particular refined cell 128 as a row header 236 based on the header probability 224 assigned to the particular refined cell 128, as well as the header probabilities 224 assigned to the refined cells 128 within a same column as the particular refined cell 128. Similarly, the header classification module 666 determines whether to classify a particular refined cell 128 as a column header 238 based on the header probability 224 assigned to the particular refined cell 128, as well as header probabilities 224 assigned to the refined cells 128 within a same row as the particular refined cell 128. Notably, the header probabilities 224 are expressed as percentages in one or more implementations.

As part of classifying the refined cells 128 as table headers 134, the header classification module 666 uses a plurality of confidence thresholds, a high confidence header threshold, a minimum header threshold, a potential header threshold, a header majority threshold, and a trivial header threshold. In one or more examples, these thresholds are expressed as percentages, and the percentages can differ based on whether the header classification module 666 is evaluating a refined cell 128 for classification as a row header 236 or a column header 238. In a specific but non-limiting example for column header classification, the high confidence header threshold is seventy-five percent, the minimum header threshold is five percent, and the potential header threshold is fifty percent. In a specific but non-limiting example for row header classification, the high confidence header threshold is thirty percent, the minimum header threshold is one percent, and the potential header threshold is fifteen percent. In these specific but non-limiting examples, the header majority threshold is sixty percent, and the trivial header threshold is ninety-five percent for both row header classification and column header classification.

In accordance with the described techniques, the header classification module 666 classifies a particular refined cell 128 within a particular row 130 as a column header 238 if the following conditions are satisfied: (1) the particular row 130 includes at least two refined cells 128, (2) the particular refined cell 128 has a header probability 224 that exceeds the minimum header threshold, (3) the particular row 130 includes at least one refined cell 128 having a header probability 224 that exceeds the high confidence header threshold, and (4) at least a threshold percentage of the refined cells 128 (defined by the header majority threshold) in the particular row 130 have a header probability 224 exceeding the potential header threshold. Similarly, the header classification module 666 classifies a particular refined cell 128 within a particular column 132 as a row header 236 if the following conditions are satisfied: (1) the particular column 132 includes at least two refined cells 128, (2) the particular refined cell 128 has a header probability 224 that exceeds the minimum header threshold, (3) the particular column 132 includes at least one refined cell 128 having a header probability 224 that exceeds the high confidence header threshold, and (4) at least a threshold percentage of the refined cells 128 (defined by the header majority threshold) in the particular column 132 have a header probability 224 exceeding the potential header threshold. If, after the refined cells 128 are classified in accordance with the conditions mentioned above, there are remaining refined cells 128 having header probabilities that exceed the trivial header threshold, the remaining refined cells 128 are classified as table headers 134.

As shown, the postprocessing system 124 outputs one or more detected tables 214 in the document 114 including the refined cells 128 and the table structure 126. Here, the refined cells 128 include the high probability cells 604, the reinstated cells 610, and the inserted cells 226. Moreover, the refined cells 128 have been modified by merging two or more overlapping cells 636 and repositioning the borders of the refined cells 128 to align the refined cells within rows 130 and columns 132, to separate overlapping cells 636, to fill gaps between adjacent cells 646, and to align cell boundaries of table boundary cells 652 with table boundaries. The table structure 126 of a detected table 214 includes the following information: the refined cells 128 assigned to the detected table 214, the refined cells 128 assigned to respective rows 130 and columns 132 of the detected table 214, span information (e.g., the row span 658 and the column span 660) of each refined cell 128, portions of table content 664 assigned to respective refined cells 128, and one or more refined cells 128 classified as table headers 134.

In one or more implementations, the table structure 126 of a table 116 as recognized by the table structure recognition system 112 is further processed by a downstream workflow/application. In accordance with a first downstream workflow, the document 114 including a table 116 having the table structure 126 is passed as input to a prompt answering model along with a prompt pertaining to the document 114 and/or the table 116. In various examples, the prompt answering model is a large language model (LLM) pre-trained to perform a variety of natural language processing (NLP) tasks including question/prompt answering, such as a generative pre-trained transformer (GPT) model, e.g., GPT-3, GPT-3.5, GPT-4, GPT-4o. Here, the prompt answering model is employed to generate an answer to the prompt or question by extracting information from the table 116 using the table structure 126. One example of this functionality includes applying the context of a row header 236 or a column header 238 to the table content 664 of a refined cell 128 that is within the same row 130 as the row header 236 or the same column 132 as a column header 238. In accordance with a second downstream application, the content processing system 104 encodes the table 116 in a configuration file format (e.g., JSON, YAML, XML) or a markup language (e.g., HTML).

### Example Procedure

The following discussion describes techniques that are implementable utilizing the previously described systems and devices. Aspects of each of the procedures are implemented in hardware, firmware, software, or a combination thereof. The procedures are shown as a set of blocks that specify operations performed by one or more devices and are not necessarily limited to the orders shown for performing the operations by the respective blocks.

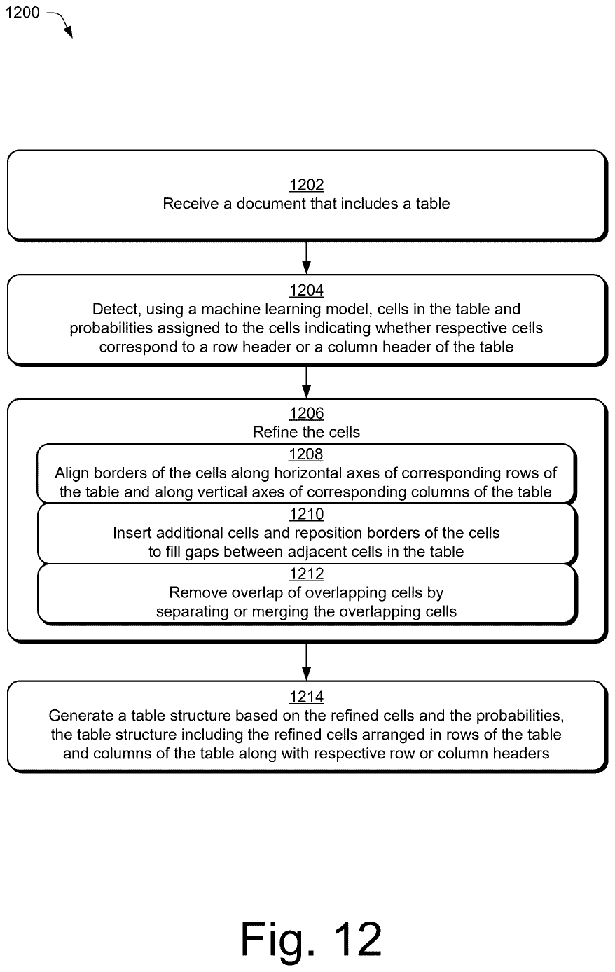

FIG. 12 is a flow diagram depicting a procedure 1200 in an example implementation of table cell detection for table structure recognition. In the procedure 1200, a document that includes a table is received (block 1202). For example, the table structure recognition system 112 receives a document 114 that includes a table 116.

Cells in the table and probabilities assigned to the cells are detected using a machine learning model, and the probabilities indicate whether respective cells correspond to a row header or a column header of the table (block 1204). By way of example, the machine learning model 118 receives the document 114. The machine learning model 118 is trained to model cells in the table directly (e.g., to output bounding boxes surrounding detected cells 120 in the table 116), as opposed to detecting rows and columns of the table 116, and then deriving cells algorithmically or heuristically. In addition, the machine learning model is trained to output a header probability 224 for each detected cell 120, e.g., a probability of the detected cell 120 of representing a row header 236 or a column header 238. Thus, based on the document 114 received as input, the machine learning model 118 outputs detected cells 120 and header probabilities 224 assigned to each detected cell 120.

The cells are refined (block 1206), and as part of this, borders of the cells are aligned along horizontal axes of corresponding rows of the table and along vertical axes of corresponding columns of the table (block 1208). For example, the detected cells 120 are assigned to rows 130 and columns 132 based on cell boundary coordinates 218 of the detected cells 120. Given a row 130 of cells, for instance, a row/column alignment module 624 is employed to align top cell boundaries of the cells in the row 130 along a first common horizontal axis, and align bottom cell boundaries of the cells in the row 130 along a second common horizonal axis. Given a column 132 of cells, for instance, a row/column alignment module 624 is employed to align left cell boundaries of the cells in the column 132 along a first common vertical axis, and align right cell boundaries of the cells in the column 132 along a second common vertical axis. This process is repeated for each of the rows 130 and columns 132, resulting in row-aligned and column-aligned cells.

As part of refining the cells, additional cells are inserted and borders of the cells are repositioned to fill gaps between adjacent cells in the table (block 1210). For instance, a missing cell correction module 616 identifies gaps 618 (e.g., that are devoid of the detected cells 120) between adjacent rows and/or adjacent columns of the detected cells 120, and inserts additional cells (e.g., inserted cells 226) to fill the gaps 618. Additionally or alternatively, the postprocessing system 124 repositions cell boundaries of the cells to fill gaps in the detected table 214 that are devoid of detected cells 120. In one example, the internal boundary correction module 644 detects a pair of adjacent cells 646 with a gap 642 separating the pair of adjacent cells 646 that is devoid of detected cells 120. In this example, the internal boundary correction module 644 repositions a first cell boundary of a first adjacent cell 646 of the pair to coincide with a second cell boundary of a second adjacent cell 646 of the pair, thereby filling the gap 642. In another example, the external boundary correction module 650 repositions the cell boundaries of table boundary cells 652 (e.g., detected cells along the perimeter of the detected table 214) to coincide with a table boundary of the detected table 214.

As part of refining the cells, overlap of overlapping cells is removed by separating or merging the overlapping cells (block 1212). For example, the overlapping cell correction module 634 determines whether to separate or merge a pair of overlapping cells 636 based on a degree of overlap between the overlapping cells 636, and cell boundary coordinates 218 of cells that adjacently surround the overlapping cells 636. If a pair of overlapping cells 636 are to be merged, the overlapping cell correction module 634 converts the pair of overlapping cells 636 to a single merged cell 638. If a pair of overlapping cells 636 are to be separated, the overlapping cell correction module 634 repositions a first cell boundary of a first overlapping cell to coincide with a second cell boundary of a second overlapping cell, thereby removing the overlap and resulting in a pair of separated cells 640.

A table structure is generated based on the refined cells and the probabilities, such that the table structure includes the refined cells arranged in rows of the table and columns of the table along with respective row or column headers (block 1214). By way of example, the postprocessing system 124 generates a table structure 126 based on the refined cells 128 and the header probabilities 224. The table structure 126 includes the refined cells 128 assigned to respective rows 130 and columns 132 of the detected table 214, one or more refined cells 128 classified as row headers 236, and one or more refined cells 128 classified as column headers 238.

### Example System and Device

FIG. 13 illustrates an example system generally at 1300 that includes an example computing device 1302 that is representative of one or more computing systems and/or devices that implement the various techniques described herein. This is illustrated through inclusion of the table structure recognition system 112. The computing device 1302 is configurable, for example, as a server of a service provider, a device associated with a client (e.g., a client device), an on-chip system, and/or any other suitable computing device or computing system.

The example computing device 1302 as illustrated includes a processing system 1304, one or more computer-readable media 1306, and one or more I/O interface 1308 that are communicatively coupled, one to another. Although not shown, the computing device 1302 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1304 is representative of functionality to perform one or more operations using hardware. Accordingly, the processing system 1304 is illustrated as including hardware element 1310 that is configurable as processors, functional blocks, and so forth. This includes implementation in hardware as an application specific integrated circuit or other logic device formed using one or more semiconductors. The hardware elements 1310 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1306 is illustrated as including memory/storage 1312. The memory/storage 1312 represents memory/storage capacity associated with one or more computer-readable media. The memory/storage 1312 includes volatile media (such as random access memory (RAM)) and/or nonvolatile media (such as read only memory (ROM), Flash memory, optical disks, magnetic disks, and so forth). The memory/storage 1312 includes fixed media (e.g., RAM, ROM, a fixed hard drive, and so on) as well as removable media (e.g., Flash memory, a removable hard drive, an optical disc, and so forth). The computer-readable media 1306 is configurable in a variety of other ways as further described below.

Input/output interface(s) 1308 are representative of functionality to allow a user to enter commands and information to computing device 1302, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1302 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” “component,” and “system” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1302. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1302, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1310 and computer-readable media 1306 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employed to implement various techniques described herein. Accordingly, software, hardware, or executable modules are implemented as one or more instructions and/or logic embodied on some form of computer-readable storage media and/or by one or more hardware elements 1310. The computing device 1302 is configured to implement particular instructions and/or functions corresponding to the software and/or hardware modules. Accordingly, implementation of a module that is executable by the computing device 1302 as software is achieved at least partially in hardware, e.g., through use of computer-readable storage media and/or hardware elements 1310 of the processing system 1304. The instructions and/or functions are executable/operable by one or more articles of manufacture (for example, one or more computing devices 1302 and/or processing systems 1304) to implement techniques, modules, and examples described herein.

The techniques described herein are supported by various configurations of the computing device 1302 and are not limited to the specific examples of the techniques described herein. This functionality is also implementable all or in part through use of a distributed system, such as over a “cloud” 1314 via a platform 1316 as described below.

The cloud 1314 includes and/or is representative of a platform 1316 for resources 1318. The platform 1316 abstracts underlying functionality of hardware (e.g., servers) and software resources of the cloud 1314. The resources 1318 include applications and/or data that can be utilized while computer processing is executed on servers that are remote from the computing device 1302. Resources 1318 can also include services provided over the Internet and/or through a subscriber network, such as a cellular or Wi-Fi network.

The platform 1316 abstracts resources and functions to connect the computing device 1302 with other computing devices. The platform 1316 also serves to abstract scaling of resources to provide a corresponding level of scale to demand for the resources 1318 that are implemented via the platform 1316. Accordingly, in an interconnected device embodiment, implementation of functionality described herein is distributable throughout the system 1300. For example, the functionality is implementable in part on the computing device 1302 as well as via the platform 1316 that abstracts the functionality of the cloud 1314.

1. A method comprising:
receiving, by a processing device, a document that includes a table;
detecting, by the processing device and using a machine learning model, a cell in the table and a probability of whether the cell corresponds to a row header of the table;
aligning, by the processing device, a border of the cell along a horizontal axis of a row of the table; and
generating, by the processing device, a table structure based on the aligned cell and the probability, the table structure including the aligned cell assigned to the row.

2. The method of claim 1, wherein the table structure further includes an indication of whether the cell is the row header.

3. The method of claim 1, wherein the machine learning model is trained to detect the cell and the probability using supervised learning on a training dataset that includes training tables, ground truth bounding boxes surrounding training cells in the training tables, and ground truth classifications indicating whether the training cells represent row headers.

4. The method of claim 1, wherein the detecting the cell and the probability includes providing the document including the table and at least one non-table element as input to the machine learning model via different input channels, the different input channels including a first input channel of the document, a second input channel of text in the document, a third input channel of images in the document, a fourth input channel of lines in the document, and a fifth input channel of font characteristics of the text in the document.

5. The method of claim 1, wherein the detecting the cell includes detecting multiple cells in the table, the method further comprising:
detecting, by the processing device and using the machine learning model, an additional cell and an object probability assigned to the additional cell indicating a likelihood that the additional cell represents either a cell object or a table object; and
removing, by the processing device, the additional cell from the multiple cells based on the object probability falling below a threshold, resulting in a reduced subset of cells.

6. The method of claim 5, further comprising identifying, by the processing device, a portion of content in the table that is external to the reduced subset of cells, and reinstating the additional cell that contained the portion of the content prior to removal.

7. The method of claim 1, wherein the detecting the cell includes detecting multiple cells in the table, the method further comprising:
identifying, by the processing device, gaps in the table that are external to the multiple cells;
inserting, by the processing device, additional cells to fill the gaps;
identifying, by the processing device, a portion of content of the table that spans two or more of the additional cells; and
generating, by the processing device, a merged cell by merging the two or more additional cells, wherein the table structure includes the merged cell.

8. The method of claim 1, wherein the aligning the border of the cell includes:
aligning the cell within the row by performing at least one of:
repositioning a first border of the cell to coincide with a first horizontal axis of the row, and
repositioning a second border of the cell to coincide with a second horizontal axis of the row; and
aligning the cell within a column of the table by performing at least one of:
repositioning a third border of the cell to coincide with a first vertical axis of the column, and
repositioning a fourth border of the cell to coincide with a second vertical axis of the column.

9. The method of claim 1, wherein the detecting the cell includes detecting multiple cells in the table, the method further comprising:
detecting, by the processing device, a pair of overlapping cells of the multiple cells; and
generating, by the processing device, refined cells by merging or separating the overlapping cells, a determination of whether to merge or separate the overlapping cells being based on a degree of overlap between the overlapping cells and border coordinates of additional cells adjacently surrounding the overlapping cells, wherein the table structure includes the refined cells.

10. The method of claim 1, wherein the detecting the cell includes detecting multiple cells in the table, the method further comprising:
identifying, by the processing device, a pair of adjacent cells of the multiple cells having a gap separating the adjacent cells that is devoid of the multiple cells; and
generating a repositioned cell by repositioning a first border of a first adjacent cell of the adjacent cells to coincide with a second border of a second adjacent cell of the adjacent cells, wherein the table structure includes the repositioned cell.

11. The method of claim 1, further comprising:
detecting, by the processing device and using the machine learning model, an additional cell of the table and table boundaries of the table; and
generating a repositioned cell by repositioning an additional border of the additional cell to coincide with the table boundaries, wherein the table structure includes the repositioned cell.

12. The method of claim 1, wherein the detecting the cell includes detecting multiple cells in the table, and the generating the table structure includes:
generating the row of the table by assigning a first group of the multiple cells to the row, the first group of the multiple cells having top or bottom borders within a first threshold distance from one another; and
generating a column of the table by assigning a second group of the multiple cells to the column, the second group of the multiple cells having left or right borders within a second threshold distance of one another, wherein the table structure includes the row and the column.

13. The method of claim 1, wherein the generating the table structure includes calculating a cell span for the cell representing a number of rows and columns in the table that the cell spans based on a degree to which the cell overlaps the number of rows and columns, wherein the table structure includes the cell span.

14. The method of claim 1, wherein the detecting the cell includes detecting multiple cells in the table and probabilities assigned to the multiple cells indicating whether respective cells in the table correspond to row headers of the table, and the generating the table structure includes classifying the cell as the row header based on the probabilities assigned to other cells that are within a same column as the cell.

15. The method of claim 1, wherein the detecting includes detecting multiple cells in the table and probabilities assigned to the multiple cells indicating whether respective cells in the table correspond to column headers of the table, and the generating the table structure includes classifying the cell as a column header based on the probabilities assigned to other cells that are within a same row as the cell.

16. The method of claim 1, further comprising assigning, by the processing device, a portion of table content of the table to the cell based on a degree of overlap between the portion of the table content and the cell.

17. The method of claim 1, further comprising encoding, by the processing device, the table in a configuration file format or a markup language based on the table structure.

18. The method of claim 1, further comprising:
receiving, by the processing device, a prompt pertaining to the document; and
generating, by the processing device and using an additional machine learning model, an answer to the prompt by extracting information from the table based on the table structure.

19. A system comprising:
a processing device; and
a memory storing instructions that are executable by the processing device to perform operations including:
receiving a document that includes a table;
detecting, using a machine learning model, a cell in the table and a probability of whether the cell corresponds to a column header of the table;
aligning, by the processing device, a border of the cell along a vertical axis of a column of the table; and
generating a table structure based on the aligned cell and the probability, the table structure including the aligned cell assigned to the column.

20. A non-transitory computer-readable medium storing executable instructions, which when executed by a processing device, cause the processing device to perform operations comprising:
receiving a document that includes a table;
detecting, using a machine learning model, multiple cells in the table;
detecting, using the machine learning model, a probability of whether a cell of the multiple cells corresponds to a header of the table;
filling gaps between the multiple cells in the table by repositioning borders of the multiple cells, resulting in refined cells; and
generating a table structure based on the refined cells and the probability, the table structure including the refined cells.
